(19) United States
(12) Patent Application Publication
(10) Pub. No.: US 2005/0171871 A1
(43) Pub. Date: Aug. 4, 2005

(54) Concentrated physical distribution system for cargo, and method therefor

(75) Inventors: Yasumasa Mizushima, Kanagawa (JP); Masami Kinugasa, Tokyo (JP); Keiichi Yumita, Kanagawa (JP); Takeshi Nakamura, Tokyo (JP); Zenta Watanabe, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation

(21) Appl. No.: 11/097,128

(22) Filed: Apr. 4, 2005

Related U.S. Application Data
(62) Division of application No. 09/980,252, filed on Feb. 21, 2002.

(30) Foreign Application Priority Data
Mar. 31, 2000 (JP) 2000-098555

(51) Int. Cl. G06F 17/60

(52) U.S. Cl. 705/28

(57) ABSTRACT

A concentrated physical distribution management system to be used in the delivery of ordered cargo to a destination is configured as a site capable of communicating mutually by using communication network lines. The site is provided with a database server. The internal processing section of the database server is composed of, at least, a shipping instruction processing section for instructing the delivery of the ordered cargo to the destination collectively including a physical distribution trader, a physical distribution expense calculation processing section for calculating physical distribution expenses necessary for the delivery of the cargo to the destination, and a cargo tracking processing section for indicating the delivery status of the cargo. The concentrated physical distribution management system manages the cargo so that all of shipping instruction concerning the cargo can be transmitted to the physical distribution trader only by accessing a portal site.

### BACKGROUND OF THE INVENTION

1. Field of the Invention

The present invention relates to a concentrated physical distribution system and/or apparatus for cargo and a method for managing a concentrated physical distribution of cargo. Further the present invention relates to a concentrated physical distribution system and/or apparatus for cargo and a method for managing a concentrated physical distribution of cargo using communication network lines or dedicated network lines.

2. Description of the Related Art

When electric or other appliances and the like manufactured by manufacturers are shipped to an abroad or the like, a current physical distribution system for such shipment carries out the following procedures. For the avoidance of the complexity of description, a case where cargo (goods such as electric appliances) is exported from the inside of a country to foreign countries by ships will be described as one example.

(1) Shipping Plan

In the case where manufactured appliances are shipped to foreign countries or the like, at first, a shipping plan including shipping basic data (6 basic information) composed of who, what, how many, when, from where, and to where is elaborated. The shipping plan is input through a personal computer as an input terminal thereof by a person in charge of the manufacturer.

(2) Booking

When the shipping plan is determined, vessel schedules that function as transportation schedules are obtained from a plurality of shipping companies. In the vessel schedules, detailed schedule data such as the name of a ship, the tonnage thereof, a port of departure, a touching port, a departure date, and the like are recorded. A desirable shipping company is determined among the plural shipping companies by the decision of loading contents and the like based on the vessel schedules. After the determination, a pre-booking of a vessel of a shipping company is performed. After that, the booking of the vessel of the shipping company is formally performed after final confirmation.

Many shipping companies execute various procedures and business works such as the business of packing for exportation, the business of customs clearance, the business of carrying cargo into or from a bonded warehouse and the business of loading, which are necessary for the exportation on behalf of the customer.

(3) Selection of Property Insurance Company

Because the cargo to be shipped is transported by marine transportation, insurance for the cargo is taken out in almost all cases. A consignor calculates the insurance of the cargo on the basis of the quantity of the cargo, the price of shipping, and the like, and the consignor selects the preferable insurance company from a plurality of insurance companies that have proposed a premium rate to the insurance. An insurance contract is made through the insurance company or an insurance agency. When insurance is offered, an insurance policy or a letter of the approval of the insurance is issued by the insurance company on the basis of the contents of the insurance offering letter.

(4) Selection of a Domestic Transport Trader

The preferable transport trader is selected among a plurality of registered domestic transport traders such as a truck transport trader for the conveyance of the cargo from the warehouse, where the cargo is kept in such as a warehouse in a factory of a manufacturer or an appointed warehouse, to a designated place.

(5) Loading and Issuance of a B/L (Bill of Lading)

When the cargo appointed by the manufacturer is loaded onto a ship, a bill of lading (B/L) is issued by the shipping company after the confirmation of the loading. In this case, an AWB (Air Waybill) is issued in case of air cargo.

Through the aforesaid various procedures, the cargo is transported from the manufacturer to a trader of a foreign country or a customer of a foreign country.

As described above, in the conventional physical distribution system, various information necessary for the ordering of goods or service are transmitted between a customer and a trader or between a customer and a plurality of traders. As mentioned above, a shipping company is determined through an individual negotiation as a work after entering the shipping plan using the input terminal. Because, even if a plurality of shipping companies are temporally registered, they are finally limited to one shipping company through individual negotiations, and if there are a plurality of shipping companies, the negotiation is individually performed. With regard to insurance companies, the situation is the same as the case of the shipping company. Then, the preferable insurance company or insurance agency is determined through individual negotiations.

Because of the individual tough negotiation, it takes a long time to select a preferable trader, and further it also requires time and cost to go to the counter of the trader. Because the exchanges of letters after the selection of the trader must be performed in conformity with the format determined by the selected trader, the works are very complicated, and confirmation works for the order are also necessary in order to avoid mistakes. In particular, in the case where such contracts are done with different plural traders in accordance with the cargo, different formats are required to each trader, and consequently, such works are obliged to spend many times.

Moreover, in the aforesaid case where an insurance company is determined, although the insurance is an item that is determined by a person in charge belonging to a manufacturer, the orderer is obliged to select an insurance company that offers the maximum insurance at the minimum insurance premium rate individually after the determination of the insurance. Consequently, only a person in charge in very restricted posts such as a veteran person in charge can manage the determination of an insurance company. Hence, the individual negotiation becomes a factor making necessarily long time and large costs.

Moreover, a bill of lading (B/L) is issued after the loading of the cargo, and the items to be filled in the bill of lading includes various subjects all of which are filled only by the transport trader. In addition, in many cases, the items are input by a specialized operator manually. Consequently, the issuance of a bill of lading is a work that requires much time and labor time.

As mentioned above, because quick decision or processing is difficult in any cases, those methods are factors that finally increase the costs of the physical distribution. Accordingly, if such information is previously gathered from a plurality of shippers, and if the preferable trader is selected among traders listed in advance, and then if the information is delivered to plural different traders, or if a shipper and a trader exchange information between then in the process of their business negotiations to cooperate about necessary information, and further if the contents of the B/L items are stored by the filling of them one by one at every information exchange to finish it as the final information of the bill of lading (B/L information), then it becomes possible to determine a trader quickly and to process the procedures quickly, and further it finally contributes a great reduction of the labor costs of the physical distribution.

### SUMMARY OF THE INVENTION

Accordingly, the present invention resolves the conventional problems as described above, and proposes a total physical distribution system capable of simplifying a lot of works of shippers and physical distribution traders by constructing a total concentrated physical distribution system by the use of communication network lines such as, especially, the Internet.

For resolving the aforesaid problems, according to a first aspect of the present invention, there is provided a concentrated physical distribution management method to be used when consigned cargo is delivered to a destination, wherein the method is processed to be electronic information capable of being mutually communicated by means of communication network lines. Accordingly the method comprises: a shipping instruction processing step of instructing delivery of the consigned cargo to the destination collectively including a physical distribution trader by accessing a specific site; a physical distribution expense calculation processing step of calculating physical distribution expenses necessary for delivery of the cargo to the destination; and a cargo tracking processing step of indicating a delivery status of the cargo, whereby the cargo can be concentratedly managed.

According to a second aspect of the present invention, there is provided a concentrated physical distribution management apparatus to be used when a consigned cargo is delivered to a destination. Namely the apparatus comprises: shipping instruction processing means for instructing delivery of the consigned cargo to the destination collectively including a physical distribution trader; physical distribution expense calculation processing means for calculating physical distribution expenses necessary for delivery of the cargo to the destination; and cargo tracking processing means for indicating a delivery status of the cargo, wherein: the shipping instruction processing means, the physical distribution expense calculation processing means and the cargo tracking processing means are configured so as to be accessed through communication network lines, and corresponding processing can be executed by accessing to a specific site.

According to a third aspect of the present invention, there is provided a concentrated physical distribution management system to be used when a consigned cargo is delivered to a destination, wherein the management system is configured to be a site capable of communicating mutually by means of communication network lines, the site is provided with a database server, the database server including inner processing sections comprises at least: a shipping instruction processing section for instructing delivery of the consigned cargo to the destination collectively including a physical distribution trader; a physical distribution expense calculation processing section for calculating physical distribution expenses necessary for delivery of the cargo to the destination; and a cargo tracking processing section for indicating a delivery status of the cargo, whereby all of shipping instructions concerning cargo to the physical distribution trader can be transmitted only by accessing to the site.

According to a fourth aspect of the present invention, there is provided a cargo insurance information making method which comprises the steps of: calculating insurance to cargo on a basis of at least shipping instruction information to be utilized as detailed cargo information, an insurance condition being a calculation standard of the insurance, and the like; selecting an insurance trader among nominated insurance traders; calculating an insurance premium by means of an insurance premium rate as a standard on a basis of the shipping instruction information, the insurance, a delivery section, and the like; and making cargo insurance information being electronic data on a basis of respective information of the shipping instruction information, the insurance, and the insurance premium.

According to a fifth aspect of the present invention, there is provided a reception method of an order of a cargo, the reception method which comprises the steps of: receiving sipping instruction information such as a kind, a quantity and a destination of the cargo in shipping instruction consignment of the cargo input through communication network lines or input on a portal site side; confirming stock information of the cargo among the received shipping instruction information; calculating physical distribution expenses in a deduced transportation route of the cargo after the step of confirming the stock information of the cargo; and delivering the calculated physical distribution expenses to a consignor side.

According to a sixth aspect of the present invention, there is provided an ordering method of cargo, wherein the ordering method comprises the steps of: taking out shipping instruction information stored in a shipping instruction database; taking out a transport schedule stored in a transport schedule database; determining a cargo transportation route in conformity with the shipping instruction on a basis of the shipping instruction information and the transport schedule; selecting an preferable physical distribution trader among physical distribution traders covering the determined cargo transportation route in a physical distribution trader list registered in a nomination database; delivering determined shipping instruction information to the selected physical distribution trader by means of communication network lines or the like.

According to a seventh aspect of the present invention, there is provided a cargo insurance information making apparatus which comprises: storing means for storing shipping instruction information to be used as detailed cargo information; storing means for storing information such as insurance conditions as a calculation standard of insurance; storing means for storing nominated insurance traders; storing means for insurance premium rate information; and calculation means for calculating the insurance and an insurance premium on a basis of each of the information; whereby insurance information being electronic data is made on a basis of the calculated insurance, the calculated insurance premium rate and the shipping instruction information used for calculation of the insurance and the insurance premium rate.

According to a eighth aspect of the present invention, there is provided a cargo insurance information making method which comprises the steps of: calculating insurance to cargo on a basis of at least shipping instruction information to be utilized as detailed cargo information, an insurance condition being a calculation standard of the insurance, and the like; selecting an insurance trader among nominated insurance traders; calculating an insurance premium by means of an insurance premium rate as a standard on a basis of the shipping instruction information, the insurance, a delivery section, and the like; and making cargo insurance information to be electronic data on a basis of respective information of the shipping instruction information, the insurance, and the insurance premium.

According to a ninth aspect of the present invention, there is provided an automatic drafting method of a draft of a bill of lading, wherein the method comprises the steps of: performing pre-booking of a specific outgoing vessel schedule selected among previously obtained outgoing vessel schedule information at a time of receiving a consigning order of cargo delivery, and using information concerning a designated outgoing vessel schedule as draft information for the bill of lading; issuing a booking instruction of the outgoing vessel schedule information for confirmation returned with an attached bill reservation number of the bill of lading; making new draft information for the bill of lading by adding shipping instruction information to the outgoing vessel schedule information for confirmation in response to a shipping requirement; and transmitting the new draft information for the bill of lading as final draft information for the bill of lading, whereby the draft information of the bill of lading is automatically made.

According to a tenth aspect of the present invention, there is provided an automatic making apparatus of draft information for a bill of lading, the apparatus comprising: storing means for storing outgoing vessel schedule information; storing means for storing cargo shipping instruction information; booking means for performing booking of a specific outgoing vessel schedule on a basis of the outgoing vessel schedule information and the shipping instruction information, both being read out from the two storing means; making means for making draft information of a bill of lading to be issued to the cargo on a basis of the outgoing vessel schedule information and the booking information; and delivery means for delivering the booking information and the draft information, whereby the draft information made by the making means is delivered to a shipping company side, and the shipping company side writes a bill number and an issuance date of the bill for making the bill of lading of the cargo.

According to an eleventh aspect of the present invention, there is provided an automatic issuing system of a bill of lading, in which a site to transmit a cargo shipping instruction and a site on a physical distribution trader side are mutually connected with a communication network line and information circulates as electronic data, the site on the shipping instruction side comprising: storing means for storing outgoing vessel schedule information; storing means for storing shipping instruction information; and draft information storing means for storing information related to an outgoing vessel schedule at a time of performing booking of a specific outgoing vessel schedule selected in a previously obtained outgoing vessel schedule table when a consigning order of cargo delivery is received; the site on the physical distribution trader side being comprising: delivery means for delivering a latest outgoing vessel schedule information; information of a bill of lading confirming means for confirming delivery of booking information on the physical distribution trader side to add a bill booking number; and bill of lading issuing means for attaching a bill number and a bill issuance data to received draft information of a bill of lading to issue the bill of lading to the cargo, whereby the draft information for the bill of lading are added in sequence in electronic data exchanging processes between both of the sites to complete the bill of lading.

In the present invention, a site connected with a communication network line is accessed by a cargo consignor or a physical distribution manager consigned by the consignor. When the site is accessed, a concentrated physical distribution management system starts, and the system selects the preferable transportation route, a physical distribution trader, and the like among those stored as internal information on the basis of input physical distribution basic six information (which will be described later). By the processing of the selection, the contents (shipping instruction information) of “which cargo”, “who”, “where”, “how many”, “from where” and “to where” are determined.

Moreover, in the processes of making the shipping instruction information, outgoing vessel schedule information from a physical distribution trader can be obtained besides the shipping instruction information. Consequently, almost all of the items necessary for a bill of lading can be obtained by the arrangement of information to be used at the time of performing booking processing such as bottom booking. Accordingly, by the utilization of the shipping instruction information and the outgoing vessel schedule information also as the information of the bill of lading at every time of the collection of those pieces of information, a draft of the bill of lading is completed when the shipping instruction information is collected.

Only the addition of a bill number and a bill issuance data of the bill of lading to the contents of the draft by a shipping company makes the draft a formal bill of lading having a value as property. Consequently, the procedures of the issuance of a bill of lading can greatly be simplified. Because insurance and the insurance premium corresponding to the insurance can be calculated by means of shipping instruction information and the information of a draft of a bill of lading when insurance traders and insurance premium rates are stored in the inside of the system, the issuance of an insurance bill becomes possible by the making of those contents in conformity of the format of an application blank and the sending of the information (as electronic information or as information written on paper) to an insurance company. It is needless to say that, when a concentrated physical distribution manager is a licensee who can conducts insurance factorage, the manager can directly issue the insurance bill on the basis of the aforesaid information. Because the insurance information making processing can also be processed by the use of the shipping instruction information and the like, the procedures of the issuance of an insurance bill can greatly be simplified. The reception of any of orders of cargo from consignors can be performed by the use of shipping instruction information and physical distribution expense information provided on a portal site side. An order of a cargo delivery to a physical distribution trader can also be determined simply by the use of the information such as the shipping instruction information of the cargo, a transport schedule, and a physical distribution trader list. The present invention constructs a total concentrated management system of physical distribution by the use of communication network lines such as the Internet.

According to the present invention, a total physical distribution system capable of simplifying the trouble of a shipper and a physical distribution trader greatly can be constructed, and consequently, both of the shipper and the trader who performs actual delivery of the cargo in response to an order from a consignor can simply draft a delivery plan for forwarding the cargo to a destination only by facing a terminal unit and inputting data into the terminal unit, and can obtain the information concerning the present place of the cargo being delivered in real time.

The concentrated physical distribution management system and the like according to the present invention are extremely suitably applied to the total physical distribution system for performing information communication by accessing only to a specific site by using communication network liens such as the Internet.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a schematic system diagram showing a part of an embodiment of a concentrated physical distribution management system according to the present invention;

FIG. 2 is a block diagram showing an embodiment of the database server in the embodiment shown in FIG. 1;

FIG. 3 is a block diagram showing an embodiment of a concentrated physical distribution management system utilizing the Internet;

FIG. 4 is a schedule table showing an example of a vessel schedule;

FIG. 5 is an explanatory diagram showing an example of preliminary provision process of a delivery schedule;

FIG. 6 is a flowchart showing an example of preliminary provision process of a vessel schedule;

FIG. 7 is an explanatory diagram showing an example of the input processing of shipping instruction information;

FIG. 8 is an explanatory diagram showing an example of a display of the inputting of shipping instruction information;

FIG. 9 is an explanatory diagram showing an example of a display of cargo location information;

FIG. 10 is an explanatory diagram showing an example of a display of decided shipping instruction information;

FIG. 11 is a flowchart showing an example of shipping instruction processing;

FIG. 12 is an explanatory diagram showing an example of the selection of the preferable trader and the instruction of delivery;

FIG. 13 is a flowchart showing an example of shipping instruction processing;

FIG. 14 is an explanatory diagram showing the update and the inquiry of the cargo tracking status;

FIG. 15 is an explanatory diagram showing an example of a display of the cargo status;

FIG. 16 is flowchart showing an example of the processing of the update and the inquiry of cargo tracking information;

FIG. 17 is an explanatory diagram showing billing for physical distribution expenses;

FIG. 18 is a flowchart showing an example of the billing processing of physical distribution expenses;

FIG. 19 is an explanatory diagram showing an example of the payment processing of physical distribution expenses;

FIG. 20 is a flowchart showing an example of the payment processing of physical distribution expenses;

FIG. 21 is an explanatory diagram showing goods price settlement;

FIG. 22 is a flowchart showing an example of price settlement processing;

FIG. 23 is an explanatory diagram about property insurance information;

FIG. 24 is a flowchart showing an example of the processing of insurance information;

FIG. 25 is a flowchart showing an example of the processing of the payment of an insurance premium;

FIG. 26 is an explanatory diagram showing an example of insurance indemnity;

FIG. 27 is a flowchart showing an example of the processing of insurance indemnity;

FIG. 28 is an explanatory diagram showing an example of the issuance of a bill of lading;

FIG. 29 is a table showing a part of the contents of a bill of lading;

FIG. 30 is a table showing the other part of the contents of the bill of lading;

FIG. 31 is a table showing the contents of physical distribution basic six information; and

FIG. 32 is a flowchart showing an example of the issuance processing of a bill of lading.

### DESCRIPTION OF THE PREFERRED EMBODIMENTS

Next, an embodiment of an electronic total physical distribution management system according to the present invention will be explained in detail by reference to the attached drawings.

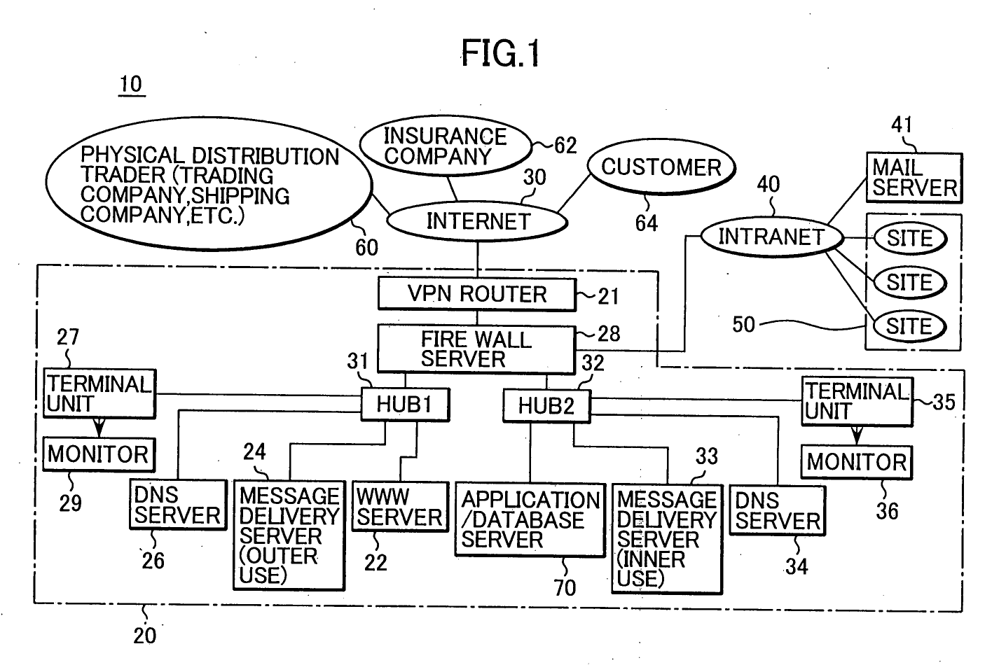

FIG. 1 is a conceptual view showing a total physical distribution management system 10 configured electronically. The management system 10 is configured so that a concentrated physical distribution management system 20, which is a main part of the present invention, is connected with the Internet 30 in this example, as a communication network lines, and further a local site 50 can be connected with the concentrated physical distribution management system 20 through an internal network such as an intranet 40.

The local site 50 is a cargo client for the total physical distribution management system 10. For example, in the case where the client is an electric manufacturer manufacturing and selling electronic appliances, each of a group of factories locating the inside or the outside of a country, a base of physical distribution and the like correspond to each site of the local site 50. To each of them, the concentrated physical distribution management system 20 has a role of the generalization base. It is apparent that the local site 50 can be configured as a site opened to public, not a site only in the group.

A plurality of sites are further located on the Internet 30 for performing business with the concentrated physical distribution management system 20. Under the circumstances of the example, a site of a physical distribution trader 60 (a general trading company, a transportation company, a shipping company and so forth) as a first one, a site of an insurance company 62 (including an agency), a communication terminal unit of an end user 64 and the like are connectable.

The concentrated physical distribution management system 20 is constructed to have a basic system as a website capable of realizing communication with the Internet 30. Accordingly, a VPN (Virtual Private Network) router 21 is used, and a fire wall server 28 is connected with the Internet 30 through the VPN router 21. A WWW (World Wide Web) server 22, a message delivery server 24 for the outside, a DNS (Domain Name System) server 26, and the like are connected with the fire wall server 28 through a first hub 31, and also a terminal unit 27 using a personal computer or the like, and a monitor 29 are connected with the fire wall server 28.

A second hub 32 is further connected with the fire wall server 28. A DNS server 34 and a message delivery server 33 for internal use are connected with the second hub 32. And also a terminal unit 35 and its monitor 36 are connected with the second hub 32 as constituents. Moreover, an application/database server 70, which will be described later, is connected with the second hub 32. And further, the local site 50 and a mail server 41 are connected with the fire wall server 28 through communication network lines such as the intranet 40 to constitute the electronic total physical distribution management system 10.

The terminal units 27, 35 are ones for entering data from portal site sides or from the outside through the Internet 30 and the intranet 40, and for searching for information. The searched results and so on are displayed on the monitors 29, 36.

As the aforesaid fire wall server 28, one configured as an application gateway can be used, and a firewall software is installed into the fire wall server 28.

A proxy server function is incorporated into the fire wall serve 28 as well as its primary fire wall function for preventing illegal accessing as the function of the fire wall server 28. Moreover, the LDAP (Lightweight Directory Access Protocol) for the use of a protocol to access a directory management database is also installed on the fire wall server 28. The well-known security function named a SSL (Secure Sockets Layer) is added to the LDAP.

The aforesaid application/database server (hereinafter, simply referred to as “database server”) 70, which is a core of the concentrated physical distribution management system 20, is located in the inside network connected with the fire wall server 28.

The database server 70 is provided for executing processes necessary for the concentrated physical distribution management system 20 (such as a shipping instruction process of cargo). However, the database server 70 also works as an application server. The database server 70 also performs the property insurance processing of cargo transport, and performs processing such as the calculation of physical distribution expenses necessary for the delivery of cargo and the like, and the delivery of such information through the Internet 30.

The TCP/IP (Transmission Control Protocol/Internet Protocol) can be utilized as a connection form for the access of the WWW server 22 and the like to the aforesaid database server 70, and a display screen to the accessing side is made on the results of the database server 70, and further the display screen data is transmitted in the form of the HTTP (Hyper Text Transfer Protocol).

Now, there are various delivery forms for the delivery of cargo such as a delivery form only by land, a delivery form including by sea by means of a cargo vessel or the like, and a delivery form utilizing an airplane dedicated for cargo. However, in the following embodiment, for the simplification of description, the delivery including the export of cargo as its part through land and sea will be mainly described. Accordingly, the aforesaid database server 70 performs the following processing.

(1) The database server 70 processes the drafting and entering a delivery plan, a cargo-seeking or car-seeking plan, and so on to shipping instruction information from the side of a cargo consignor (shipping instruction information processing function section).

A physical distribution trader (such as a delivery trader, an exportation trader, a shipping company) is designated on the basis of the shipping instruction information, and also the draft of a bill of lading (B/L) is prepared by the use of the information to be exchanged with a shipping company on the basis of this shipping instruction information, and further the draft of an insurance policy (an insurance application) and so on are prepared.

(2) The database server 70 performs the estimate, the billing and the management processing of the physical distribution expenses based on the shipping instruction information.

The database server 70 estimates the physical distribution expenses and delivers the estimation to the cargo consignor side. Moreover, the database server 70 performs the billing of the physical distribution expenses to the cargo consignor. And further the database server 70 performs the electronic settlement processing for the payment of the physical distribution expenses to the physical distribution trader. And thus the database server 70 manages the billing and the payment of the physical distribution expenses.

(3) The database server 70 prepares a cargo tracking information for recognizing the present status of the cargo by means of the information from the physical distribution trader.

When a shipping instruction is issued, the consigned cargo is delivered via each physical distribution trader. The database server 70 manages the tracking information such as “where the cargo is transported now”, i.e. the date and the time of the transportation and the delivery of the cargo in a country, and the date and the time of the transportation and the delivery of the cargo in foreign countries.

(4) Cargo Management Processing

The database server 70 manages the actual object (cargo) until the cargo reaches a customer as an end-user finally. For the sake of the management, a stock information and a cargo tracking information are utilized. Thereby, it can be recognized about shipping base information such as who (owner or client), what (products and parts), how many (quantity) and where (place).

A significant electronic total physical distribution management system having advantages that cannot be obtained by the conventional physical distribution system such that the work of receiving an order of cargo and the work of ordering cargo are made to be simplified and draft information composed of a plurality of items being the origin of a bill of lading can simply be made and the like.

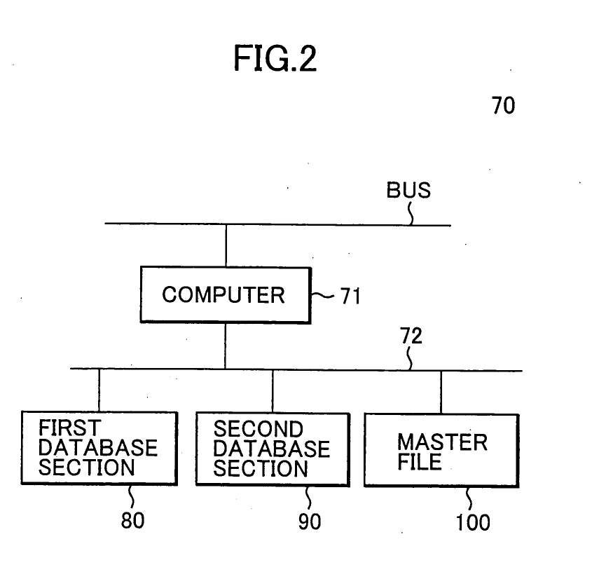

For executing the aforesaid processing, the database server 70 is provided with a main frame computer 71 for the management of the database server 70 as shown in FIG. 2, and further a plurality of portals (web portals) are prepared for realizing the aforesaid processing of (1) through (4) in the present embodiment, and then a first database section (data storing means) 80 corresponding to the web portals is connected with an internal bus (connection cable for a communication) 72 through a hub.

Besides, a second database section (data storing means) 90 for storing histories of the shipping of cargo, the payments of physical distribution expenses, and the like, and a master file 100 for storing information necessary for the calculations of necessary costs such as the physical distribution expenses, insurance premiums, and the like are connected with the internal bus 72.

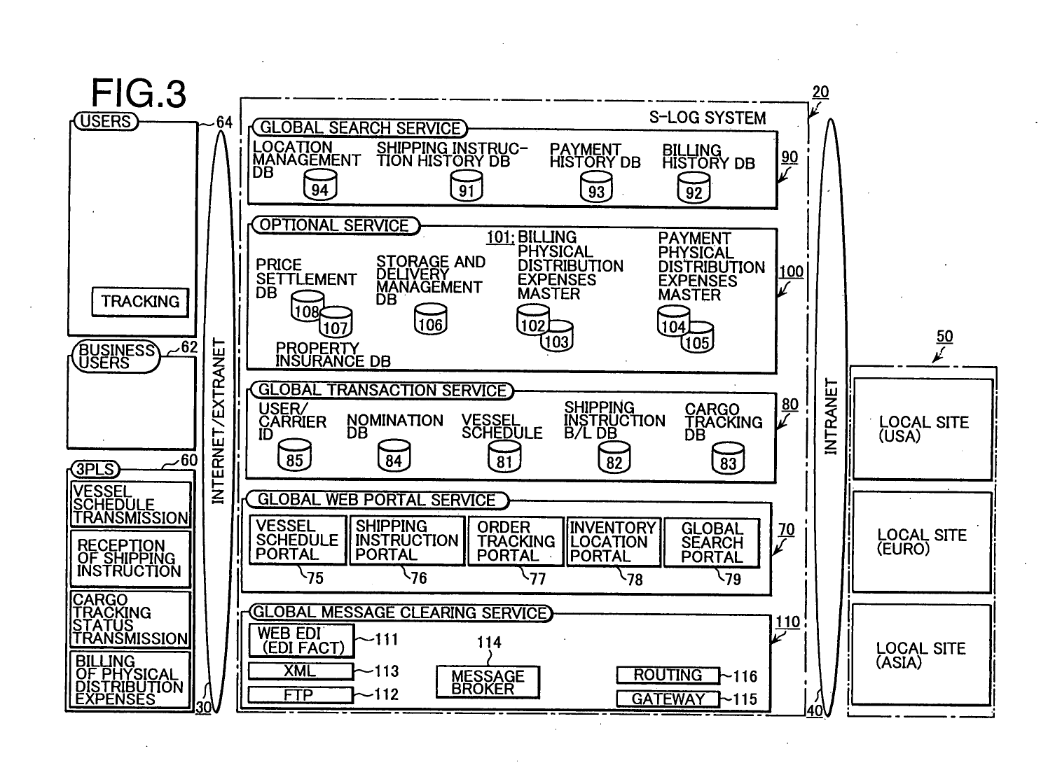

The first database section 80 is provided with at least the following five web portals as shown in FIG. 3.

(a) Vessel schedule portal 75 for being accessed when the departing vessel schedule is input or output;

(b) Shipping instruction portal 76 for being accessed when the shipping instruction information is input or output;

(c) Order tracking portal 77 for being accessed when the cargo tracking information is input or output;

(d) Inventory location portal 78 for being accessed when the cargo location information is input or output; and

(e) Global search portal 79 for being accessed when general information such as physical distribution expenses is input or output.

For these five web portals 75 through 79, the first database section 80 is provided with at least the following databases when it is required. However, the databases and the aforesaid web portals do not accord with each other completely.

(a) Database 81 for storing vessel schedules,

(b) Database 82 for storing the information of shipping instructions and a bills of lading,

(c) Database 83 for Storing the cargo tracking information,

(d) Database 84 for registration of the physical distribution traders (Nomination) to be used when the Physical distribution trader is selected, and

(e) ID database 85 for storing names, IDs and the like of cargo consignors, physical distribution trader and the like.

The second database section 90 is provided with a database 91 for the management of shipping instruction histories, a database 92 for the management of billing histories, a database 93 for the management of payment histories, and a database 94 for the management of cargo locations.

As the master file 100, there is a master file 101 related to the physical distribution expenses, and the master file 101 further includes master files 102, 103 for billed physical distribution expenses and the management of the billed physical distribution expenses, and master files 104, 105 for paid physical distribution expenses and the management of the paid physical distribution expenses.

Besides, there is a master file 106 for the management of cargo storage and delivery, and the master file 106 is made to be a database form. Similarly, a database 107 related to a property insurance, a database 108 for price settlement, and the like are provided.

Then, for the accessing of information to the concentrated physical distribution management system 20, a global message clearing service section 110 is provided for performing the transfer of information from the Internet 30 and the intranet 40. The clearing service section 110 is provided with a plurality of communication protocols for automatic selection of the protocols for the received data.

As the plural communication protocols, there are provided, for example, an EDIFACT (Electronic Data Interchange For Administration, Commerce and Transport) 111, which is an international standard for online commercial transactions, especially for the reception and the sending of orders, settlements, and the like, by the Internet among an EDI (Electronic Data Interchange) for data conversion according to the protocols of received data, a FTP (File Transfer Protocol) 112, an XML (eXtensible Markup Language), which is a page description language to be utilized in place of the EDIFACT, and the like. Consequently, the aforesaid databased server 70 also functions as an EDIFACT server for the electronic commercial transactions that are necessary to intercommunicate through the Internet 30 and the intranet 40.

The data that are converted into an appropriate protocol are transmitted to the portal sites inside the system through a message broker 114, a gateway 115, a router 116 and so on.

Next, examples of processing sequences of the concentrated physical distribution management system 20 in the thus configured electronic total physical distribution management system will be described in due order. It is supposed in the description that the various software executing the following various processing is stored in the database server 70. It is also possible that a database server is provided to every principal portal to execute the processing separately under consideration of the increase of the cargo consignors.

(1) Prior Presentation System of Cargo Transportation Schedules.

(Departing Vessel Information Provision System)

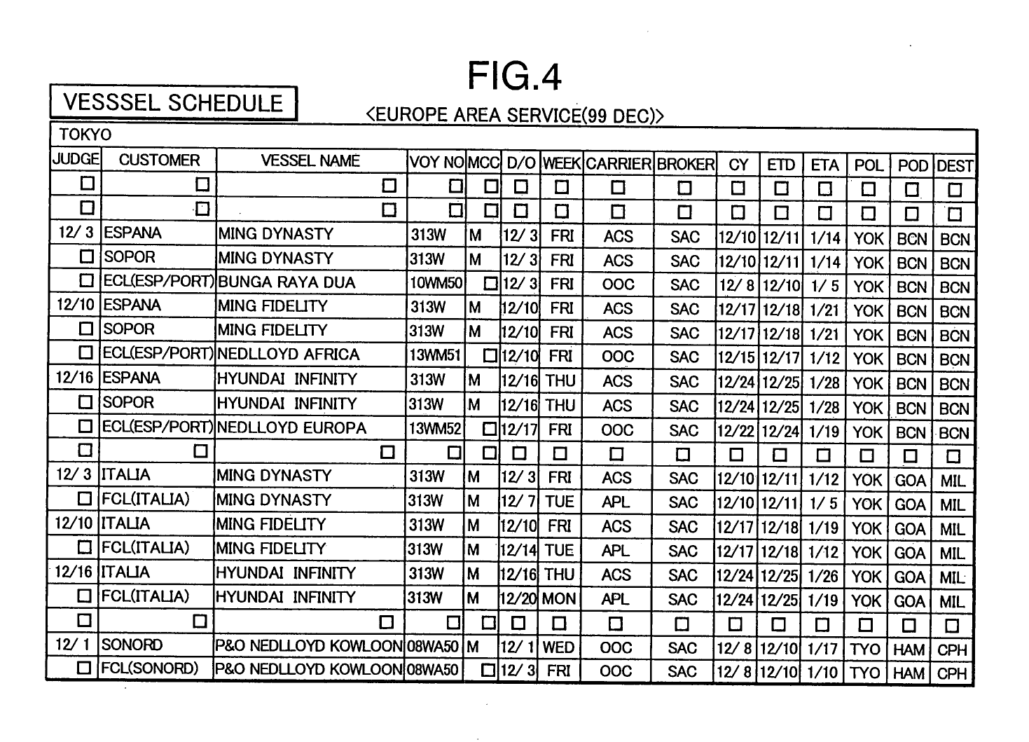

This system is a system that provides the latest information of a departing vessel schedule table (vessel schedule) as shown in FIG. 4 that is owned by a plurality of physical distribution traders for cargo consignors (shippers).

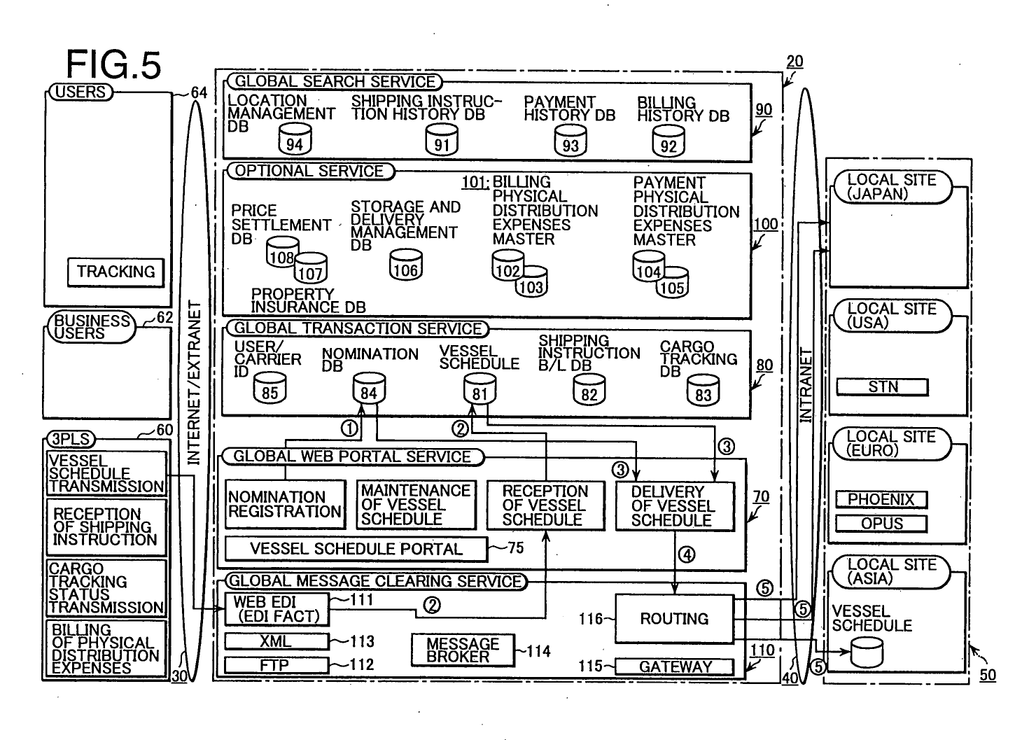

For accomplishing the purpose, as shown in FIG. 5, a plurality of previously selected physical distribution traders are registered, and the registration information is stored in the nomination database 84. Then, the latest vessel schedule is supplied from the registered site of the physical distribution trader 60 through the Internet 30. The vessel schedule is transferred through the message clearing service section 110 in conformity with the WEBEDI (EDIFACT) 111, and is received by the vessel schedule portal 75 to be registered in the database 81 for the vessel schedules after that.

The transmission of the vessel schedules may automatically be performed at every fixed time, or may automatically be performed at every update of the Vessel schedules. The contents of the transferred information are the registered physical distribution traders, the vessel schedules concerning the registered physical distribution traders, and the like. The delivery information is simultaneously transmitted to a plurality of shippers (cargo consignors) constituting the local site 50 through the intranet 40 in the example shown in FIG. 5. By the information supplying system, the shippers can always obtain the latest vessel schedule (including alterations) without inquiring to the individual physical distribution trader.

Incidentally, the numbers enclosed by circles shown in FIG. 5 indicate the processing order. The numbers written in each figure to be referred in the following description have the same meaning.

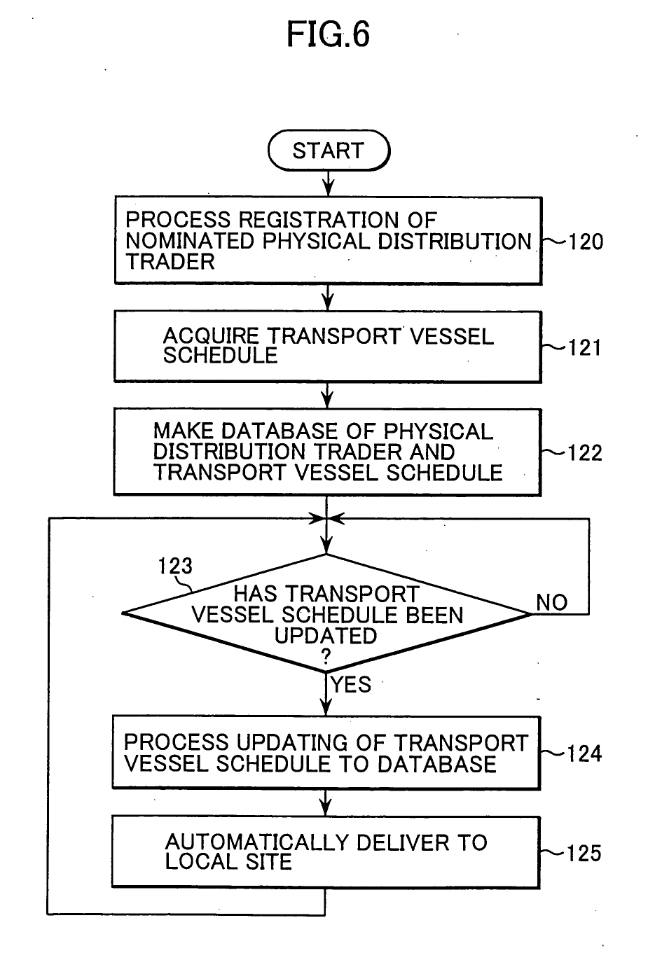

FIG. 6 is a flowchart showing an embodiment realizing the previous presentation system of the vessel schedules. In the embodiment, there are performed the registration processing of the nominated physical distribution traders and the processing of making a database of the vessel schedules (storing processing) from the nominated physical distribution traders, especially from shipping companies (steps 120, 121, 122).

Next, the existence of the update of the vessel schedules is checked, and when a new vessel schedule is received, the update processing of the database 81 is allowed (steps 123, 124). Then, the transmission processing of the updated new vessel schedules to the local site 50 is automatically performed (step 125). Thereby, the vessel schedules are supplied in advance (step 125). Consequently, these processing is automatically performed at every time of updating the vessel schedules.

(2) Processing System of Shipping Instruction Information

It is considerable that there are two cases of a shipping instruction input into the concentrated physical distribution management system 20. That is, a case where the sipping instruction is input from the sipper side, i.e. the customer 64 side or the local site 50 side through the Internet 30 or the intranet 40; and a case where the sipping instruction is directly input from the portal side of the concentrated physical distribution management system 20, i.e. terminal unit 35 side.

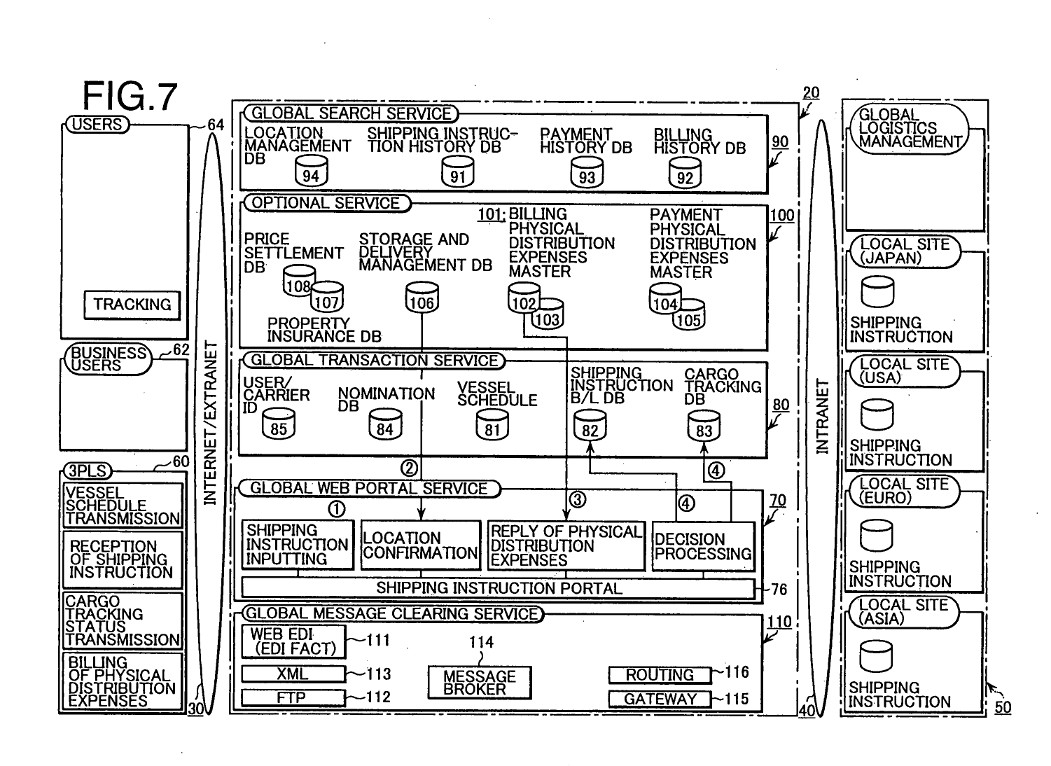

If the case where the sipping instruction is input from the portal site side is examined, the shipping instruction information (six basic information) is entered from the portal 76 shown in FIG. 7 by the use of the terminal unit 35. Herein, the “six basic information for the shipping instruction” are six pieces of information of “who”, “what”, “how many”, “when”, “from which”, and “to which”. As long as the basic six information exist, the cargo that is asked can be sent to the destination thereof.

When the shipping instruction is issued, the storage and delivery information of the cargo is taken out of the database 106 that performs the storage and delivery management of the cargo, and the confirmation of the place (warehouse, sales office and so forth) where the instructed cargo is located, i.e. the confirmation of the location, is performed. If the instructed cargo is not kept as a stock, an instruction of additional manufacturing or the like is sent to the factory of the manufacturer.

Because the physical distribution expenses for the transportation of the cargo as the object to the destination can be calculated when the basic six information for the shipping instruction are obtained, the information of the physical distribution expenses for the calculation of the total physical distribution expenses including a physical distribution trader, an insurance trader and the like is taken out of the master file 102 in which the information for the physical distribution expenses is stored to perform the calculation based on the transportation route. And thereby the physical distribution expenses can be obtained.

After the selection of the physical distribution trader and the determination of the transportation route and the like, almost all of the necessary items to be filled in the bill of lading issued by the shipping company can be prepared. Accordingly, the information of these items is stored in the database 82 as the drafting information of the bill of lading together with the shipping instruction information. After the determination of the shipping instruction, the designated model name of the cargo and the like are stored in the corresponding database 83 as the cargo tracking information.

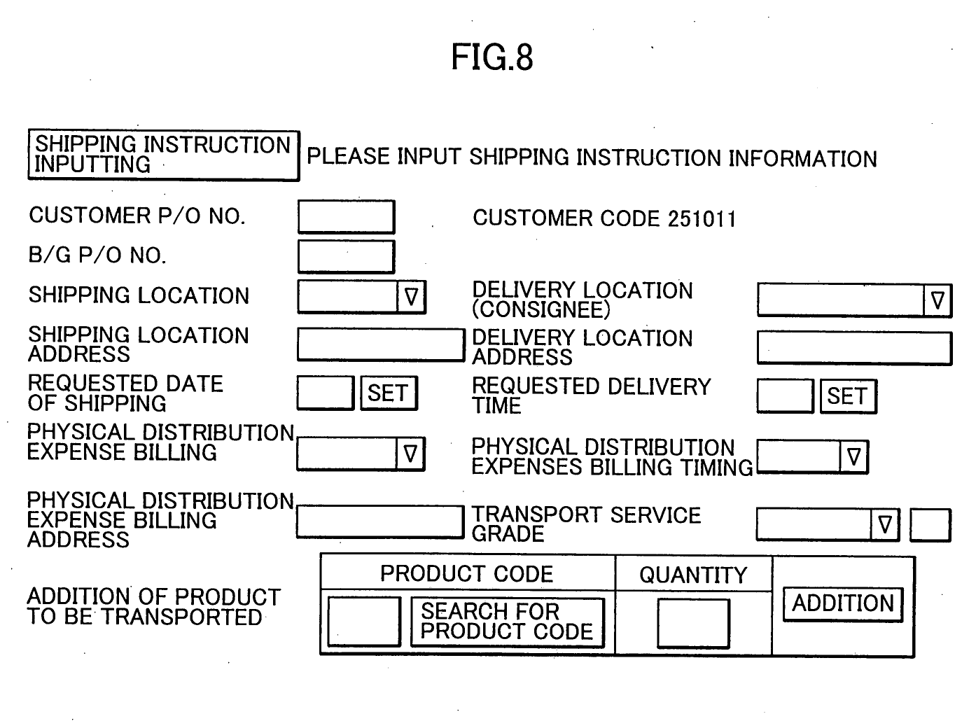

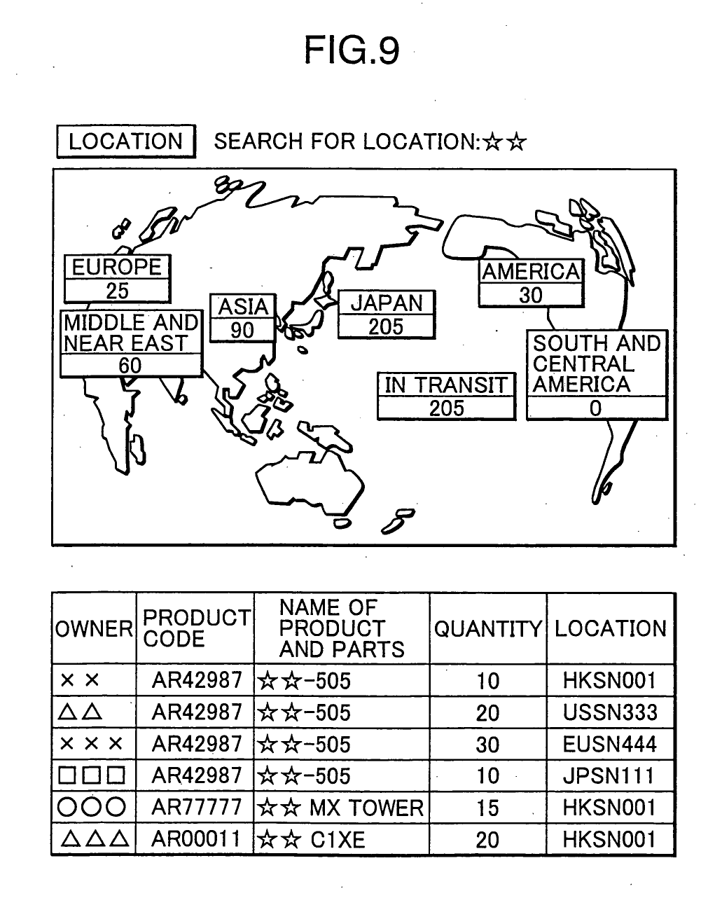

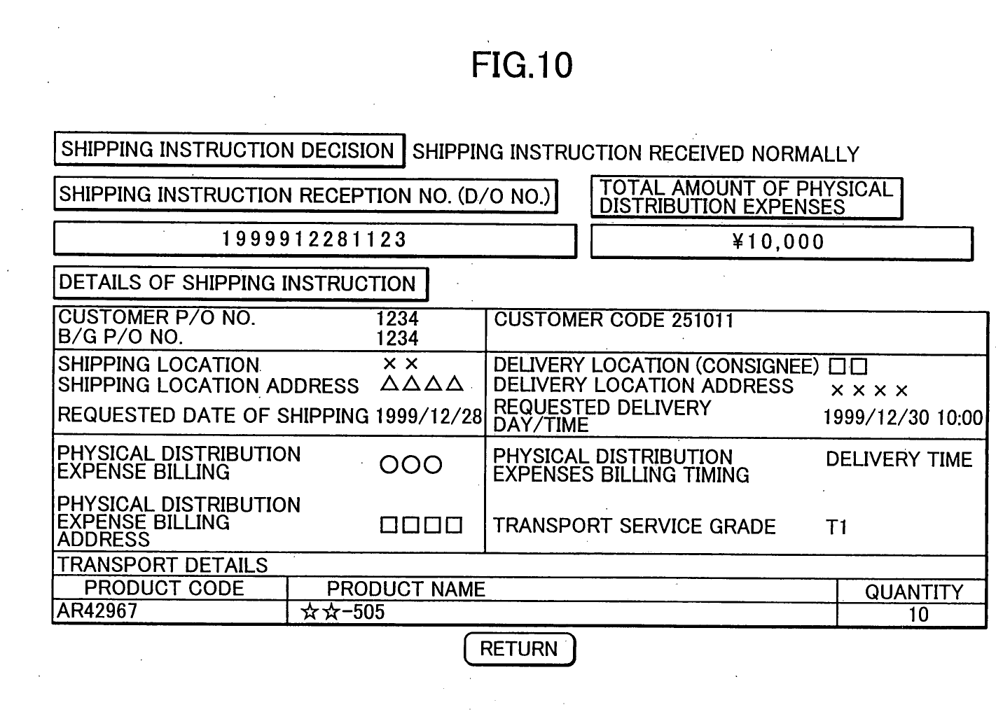

In the case where the shipping instruction information is not entered at the portal site side, the fixed shipping instruction information from the local site 50 is received, the received information is then stored in the databases 82 and 83. FIG. 8 illustrates a display screen showing an input example of the shipping instruction information. FIG. 9 illustrates a display example of the cargo location information. FIG. 10 illustrates a display example of the fixed shipping instruction information.

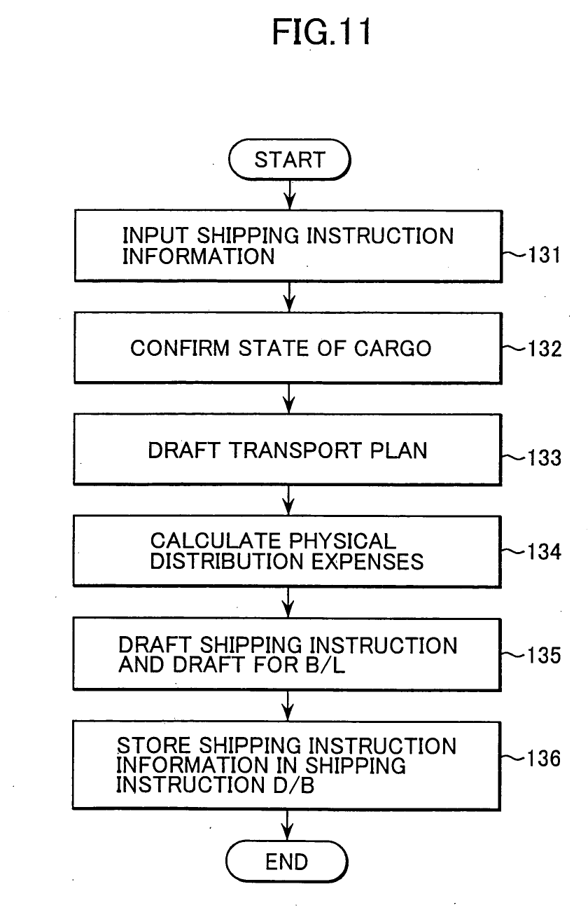

FIG. 11 is a flowchart showing an example of the flow of the processing. When the information of the shipping instruction is input (step 131), the confirmation of the status of the cargo is performed (step 132). If the delivery of the cargo is possible according to the confirmation of the status, a delivery plan is drafted based on the shipping instruction information, and the physical distribution expenses is calculated in accordance with the transportation route of the cargo (steps 133, 134).

The drafting processing of the bill of lading is executed simultaneously with the drafting processing of the delivery plan (step 135). Thus drafted shipping instruction information is stored in the corresponding database, and also is stored in the database for the cargo tracking. Thus the first step of a series of shipping instruction processing ends (step 136).

As described above, the reception processing of the cargo is performed by receiving the shipping instruction information such as category of the cargo, the quantity of the cargo and the addressee of the cargo to a shipping instruction consignment of the cargo input through the Internet 30 or the intranet 40 or input on the portal side, and then by confirming the stock information of the cargo, and further by performing the processing such as the deduction of a transportation route of the cargo and the calculation of the physicals distribution expenses of the transportation route.

Also, it is possible to perform the ordering processing of the cargo by fixing a cargo transportation route and a physical distribution trader that follow the shipping instruction information of the cargo and a transportation schedule shipping instruction of the cargo.

(3) Selection of the Preferable Trader and Delivery Instruction System

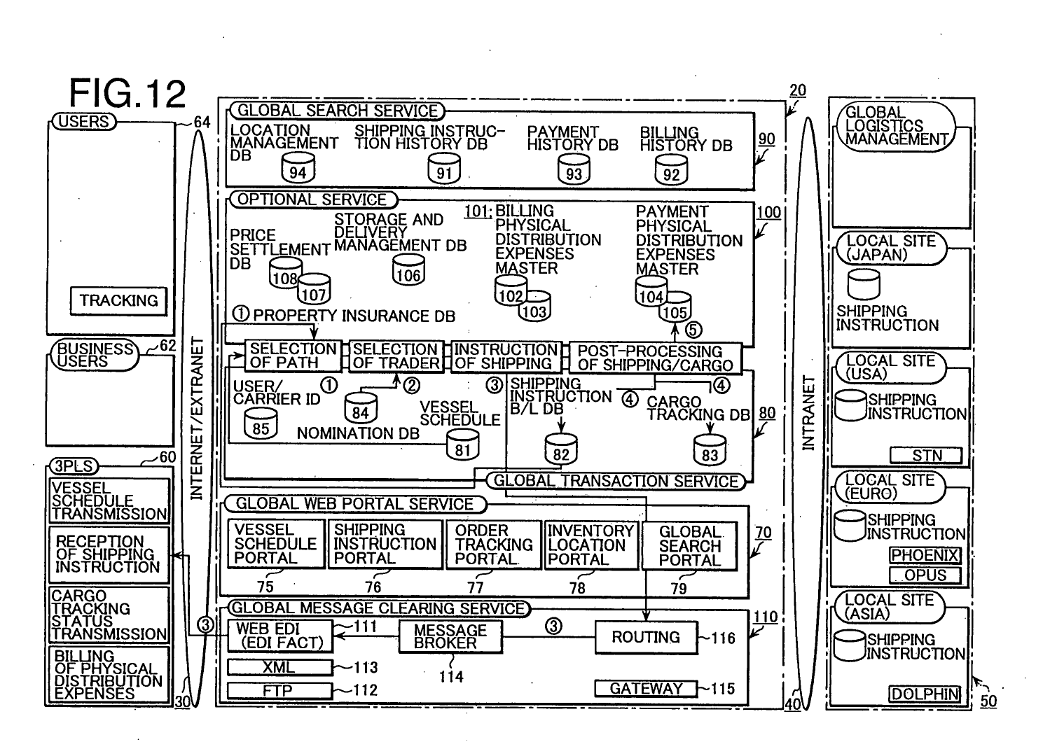

As a second step of the shipping instruction processing, the selection of the physical distribution trader and the instruction of delivery are cited. The preferable physical distribution trader is selected on the basis of the basic six information for the shipping instruction, and the delivery instruction of the cargo is performed. The selection of a trader is performed in conformity of the following route. The route is described by reference to FIG. 12.

First, the shipping instruction information is taken out of the database 82 for shipping instructions, and also a vessel schedule is taken out of the database 81 for the vessel schedules. Then, a cargo transportation route is determined.

Next, the registered physical distribution trader list is taken out of the database 84 for nomination for the selection of the preferable physical distribution trader among the physical distribution traders having a service on the fixed cargo transportation route. Because the cargo transport information of the past is stored in the information of physical distribution traders, a trader, who meets the conditions such as the cheapness of its shipping charge, the shortness of the number of transport days, the lower rate of its accident, and the like, is selected by the reference to the cargo transport history information.

The shipping instruction becomes the final one by the determination of the physical distribution trader, and then the shipping instruction information (delivery instruction information) is transmitted to the physical distribution trader 60 through the Internet 30. A formal cargo delivery contract is concluded by the deliver processing. After the shipping instruction is fixed, the fixed shipping instruction information is stored in the database 82 for shipping instruction as the post-processing of the fixing of the shipping instruction. Moreover, the information is also stored in the cargo tracking database 83. At the same time, the calculated expense information of the physical distribution is stored in the master file 105 for the management of the physical distribution expenses.

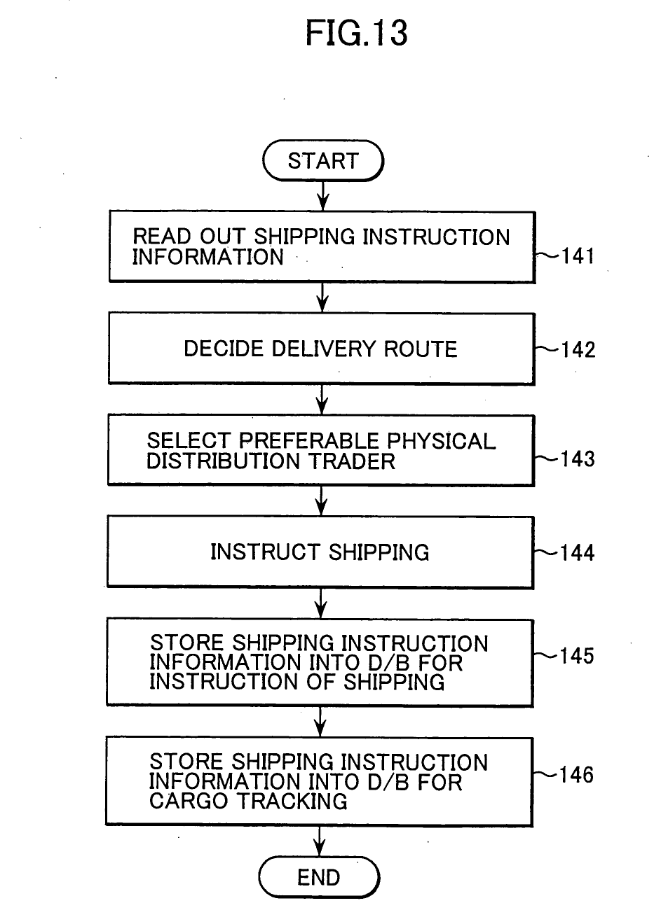

FIG. 13 is an example of a flowchart when the series of processing is executed.

Shipping instruction information is read out from the database 82 for shipping instruction, and the vessel schedule is read out from the database 81 for vessel schedule (step 141). A transportation route of the cargo is determined on the basis of these information (step 142). The preferable physical distribution traders (a transport trader, an export trader, a shipping company and the like) are selected among the physical distribution traders having the transportation service at the route (step 143).

After the selection of the physical distribution trader, the shipping instruction is in turn transmitted to the physical distribution trader site 60 through the Internet 30. And, the shipping instruction information is stored in the database 82 for shipping instruction and the database 83 for cargo tracking (steps 144, 145, 146). Moreover, in the embodiment, the shipping instruction information is also recorded in the master file 105 for the management of the physical distribution expenses managed for the payment of the physical distribution expenses to the physical distribution traders, and then the series of processing is completed.

(4) Update of the Cargo Tracking Status and Inquiry System

There is a case where the latest tracking status of the cargo instructed to be shipped, namely how is the status of the cargo, is desired to be known. It is desired by the costumer who is to receive the cargo actually and the physical distribution trader himself besides the shipper. The update and inquiry system for the response to such request is equipped on the portal site side.

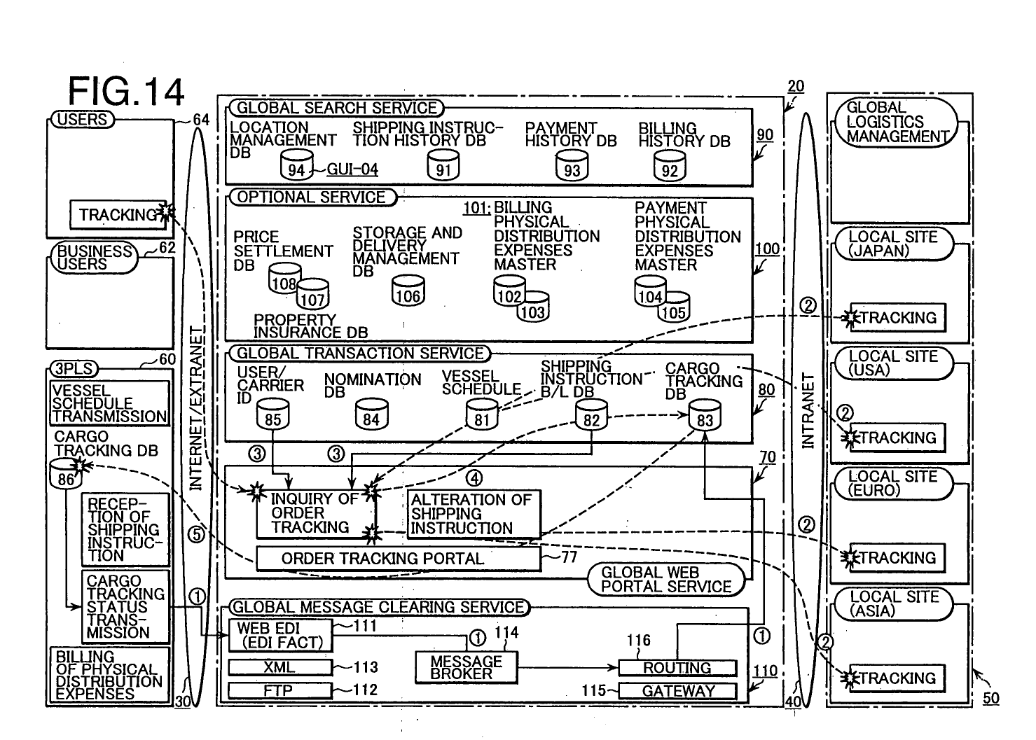

As shown in FIG. 14, the following information as well as the basic information such as the shipping of the cargo, the date and time of carrying into a warehouse, and the date and time of the completion of the shipping and the delivery of the carried cargo is updated as the latest information in order at the cargo tracking database 83.

The information is the tracking information concerning which point the cargo having received the delivery instruction passes now, namely in which status the cargo is, the status in which the cargo is kept in a warehouse (in an office), the status in which the cargo is being forward carrying in, the status in which the cargo is collected and packed, the status in which the cargo is packed and transported (the status of being forward loaded and shipped), a cross docked status in which a plural pieces of the cargos are collected together, the status in which the cargo is kept as a stock on the delivery side, or the status in which the cargo is collected and packed to the customer.

It is needless to say that as for the cargo to be exported the cargo status information such as the cargo is in a procedure of customs clearance for export, or the cargo has sailed out, or further has arrived in a port, or further is in a procedure of customs clearance for import is fully stored in the cargo tracking database 83. Consequently, the present location of the cargo can be known by the search of the database 83.

Such principal cargo tacking information is stored in the cargo tracking database 83 loaded on the portal site from the physical distribution trader through the Internet 30. The cargo tracking information is always kept updated.

Moreover, by the inquiry of the cargo tracking status, the portal site addresses of the cargo consignors (users), the attribute information of the cargo (such as the name of the cargo, the quantity of the cargo and the discharge location of the cargo), and the like taken out of the database 85 of cargo consignors and physical distribution traders (carriers) can be referred through the portal 77 for tracking inquiry. Besides, the shipping instruction information, the information of the bill of lading, and the like can also be referred through the database 77 for tracking inquiry.

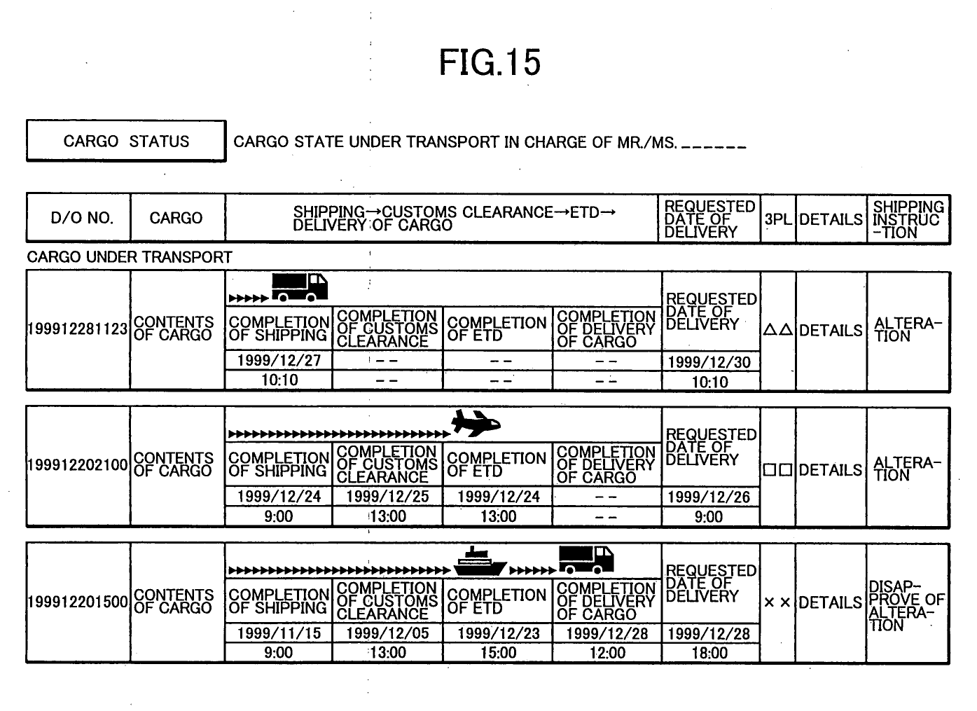

Consequently, the cargo consignors on the local site 50 and the customers 64 can search for the tracking status of the cargo by accessing the portal site 77 for tracking inquiry through the intranet 40 and the Internet 30, respectively. Examples of the displays of the cargo status are shown in FIG. 15. Moreover, when the minute cargo tracking information that is not in the cargo tracking database 83 is desired to be known, the information can be known by the access to the cargo tracking database 86 on the physical distribution trader side.

It is moreover possible to change the shipping instruction information. For example, it is possible to change the destination or delivery date and time.

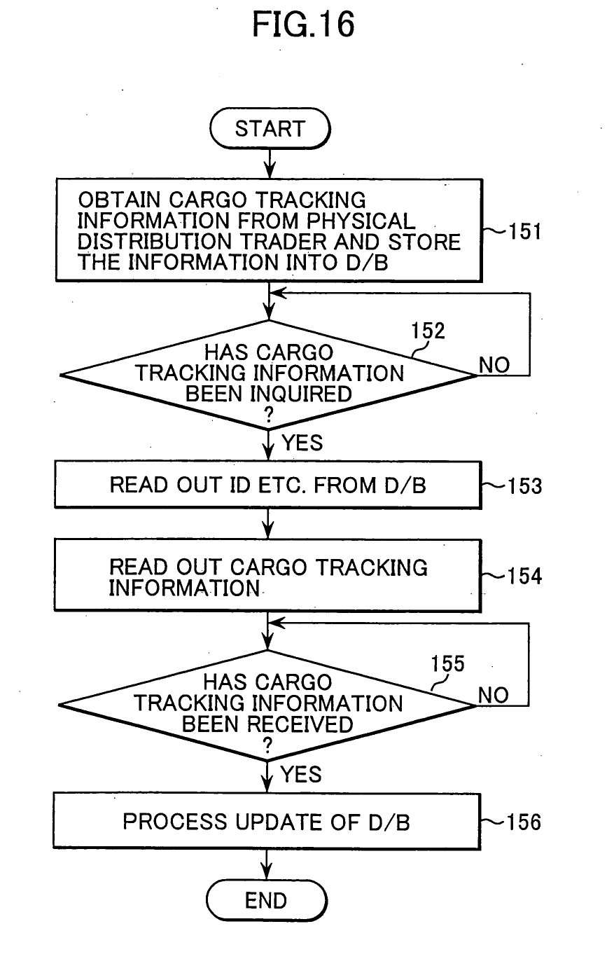

FIG. 16 is a flowchart showing an example of the processing for tracking inquiry.

At first, the latest cargo tracking information is obtained from the physical distribution trader to store in the database 83 (step 151). Next, it is checked whether the inquiry of the cargo tracking information is performed or not (step 152). When the inquiry is done, the information such as the ID of the physical distribution trader is taken out of the database 85. Moreover, the shipping instruction information is taken out of, the database 82 (step 153). Then, the latest cargo tracking information is taken out by the reference to the database 83 on the basis of the designated cargo and the ID thereof (step 154). Thereby the latest tracking information of the cargo can be searched for.

Successively, the concentrated physical distribution management system 20 becomes a status for waiting the accessing from the trader. When the reception status of the cargo tracking is confirmed (step 155), the update processing of the information in the database 83 is executed (step 156), and then the information in the database 83 is exchanged with the latest cargo tracking information. By the execution of such processing, the latest tracking information is always stored in the database 83, and consequently the cargo consignor and the like can clearly recognize the current place where the corresponding cargo exists.

(5) Billing System of Physical Distribution Expenses

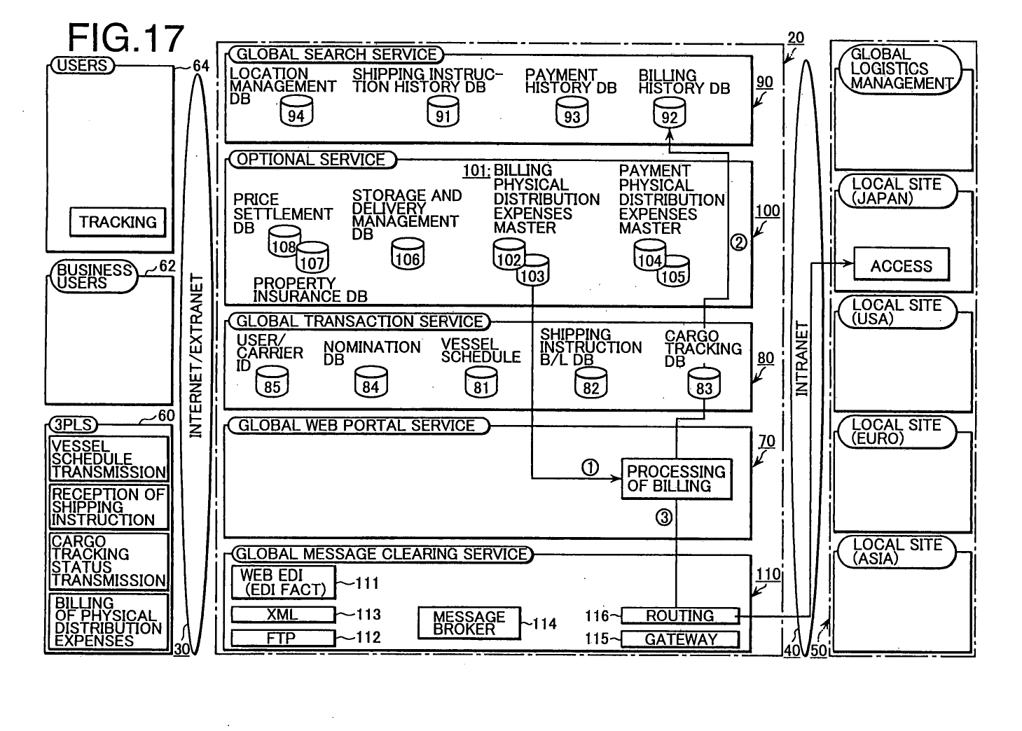

If the basic six information and the like for the shipping instructions are entered, the transportation route of the cargo is fixed. By the fixing of the transportation route, the costs necessary for the cargo delivery (physical distribution expenses) can be calculated. The physical distribution expenses are kept on the physical distribution expenses management file 105 side shown in FIG. 17.

For actually billing the physical distribution expenses to the cargo consignor, a manager of the portal site executes the billing by activating the software for billing processing prepared on the portal site side. That is, when this software is activated, a bill is automatically issued by taking out the physical distribution expenses concerning the cargo consignor form the physical distribution expenses management master file 105.

When the bill is issued to the cargo consignor, the name of the cargo consignor, the billing date, the contents of billing and the like are stored in the billing history database 92 for the storing of the billing as a billing history. Then, the date of the billing is delivered to the specific cargo consignor side in the local site 50 through the intranet 40. By the use of the billing system like this, the bill is automatically issued to be delivered to a specific cargo consignor side.

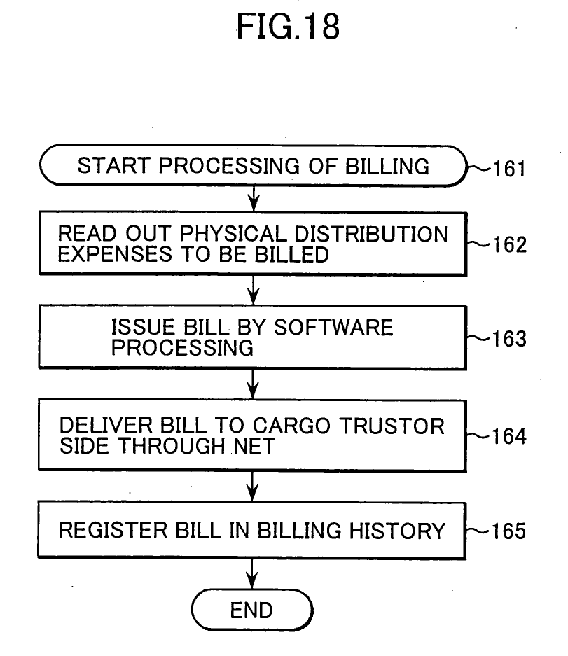

FIG. 18 is a flowchart showing an embodiment of the processing of automatic issue of a bill. When the processing of issuing a bill is started (step 161), the physical distribution expenses to be billed is read out (step 162). The bill of the physical distribution expenses is issued to the cargo consignor (step 163). The bill is made in conformity with the EDIFACT. The bill of the physical distribution expenses is delivered to the cargo consignor side through the intranet 40. Moreover, the contents of the delivered billing are recorded in the billing history database 92 (steps 164, 165).

(6) Physical Distribution Expenses Payment Processing System

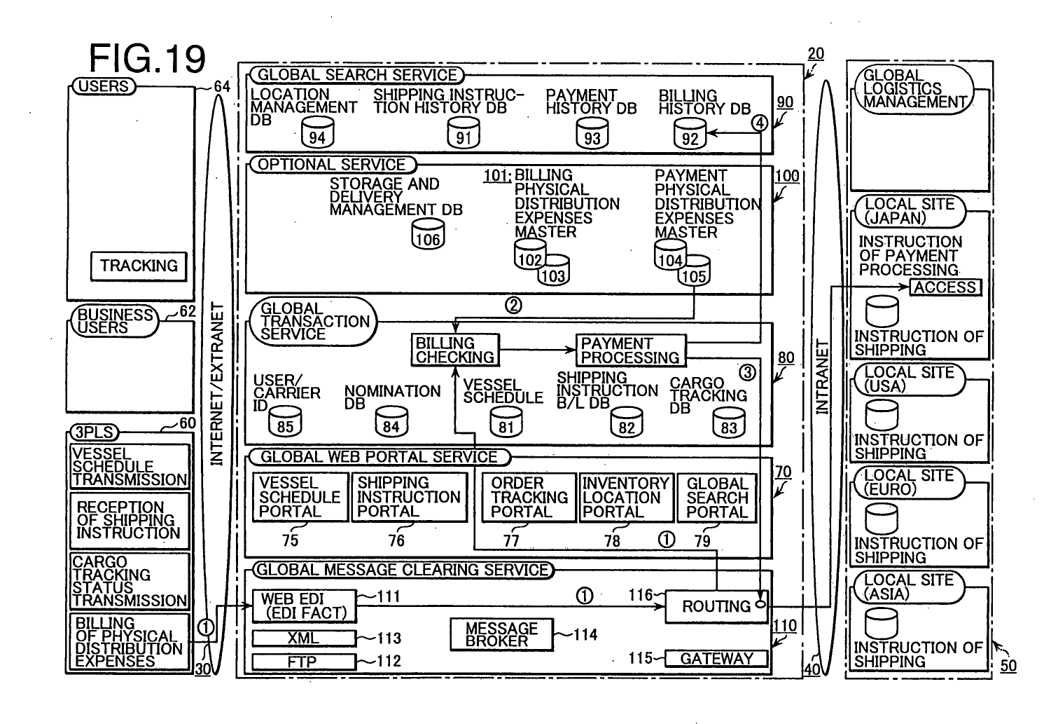

When the payment of the actual physical distribution expenses is billed by the physical distribution trader, the processing shown in FIG. 19 is performed. At first, when the payment of the physical distribution expense concerning the delivered cargo is billed by the physical distribution trader 60 through the Internet 30, the software for billing check is started. The billing is collated with the physical distribution expenses information concerning the delivered cargo taken out of the physical distribution expenses management master file 104. When the results of the collation are agreed, the drafting processing of the payment instruction information is executed. The payment instruction information is stored in the database 92 for storing payment histories, and besides an instruction for the urging the payment processing is transmitted to the corresponding cargo consignor side among the local site 50 (deliver for the payment processing). When a finance management system is provided on the cargo consignor side, the instruction is accessed by the finance management system and processed as an unpaid process.

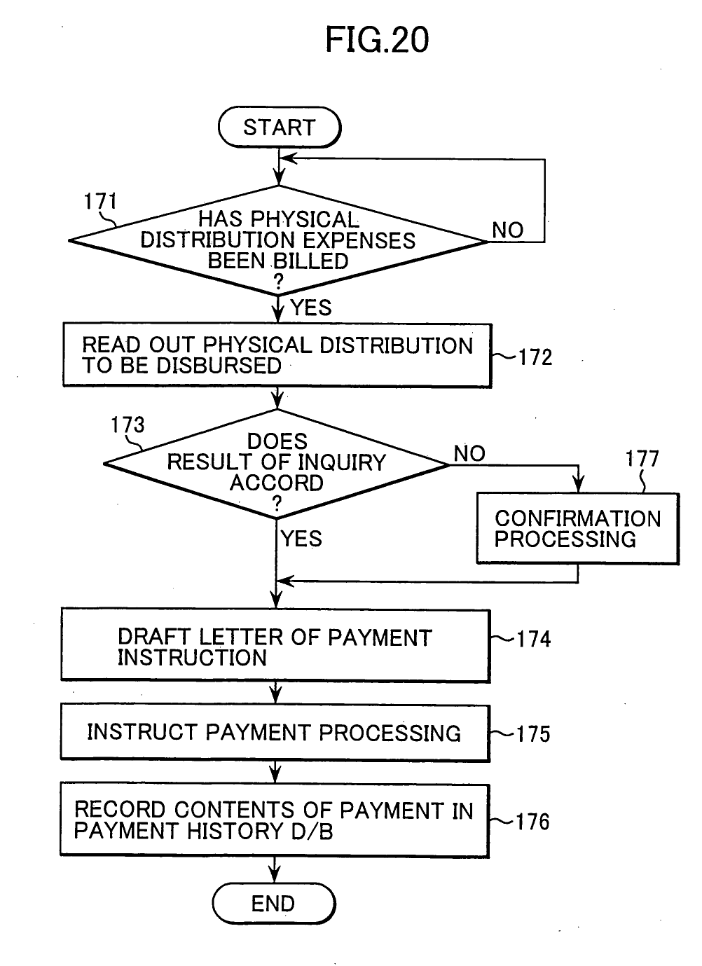

FIG. 20 shows an example of the payment processing.

When the payment billing of the physical distribution expenses is received, the corresponding payment physical distribution expenses are read out from the payment physical distribution expenses management master file 105 to collate them (steps 171, 172, 173). When the result of the collation indicates that the contents of them are agreed, a payment instruction letter is issued (step 174), and the letter is delivered to the corresponding local site 50 in a form of electronic data through the intranet 40 (step 175). At the step of the completion of the payment instruction, the contents of the payment are recorded in the database 92 for the payment histories, and the payment processing is completed (step 176). When the processing at the step 173 indicates that the contents of them are not agreed, the confirmation processing thereof is performed (step 177), and after the confirmation the processing after the step 174 is performed.

(7) Cargo Price Settlement System

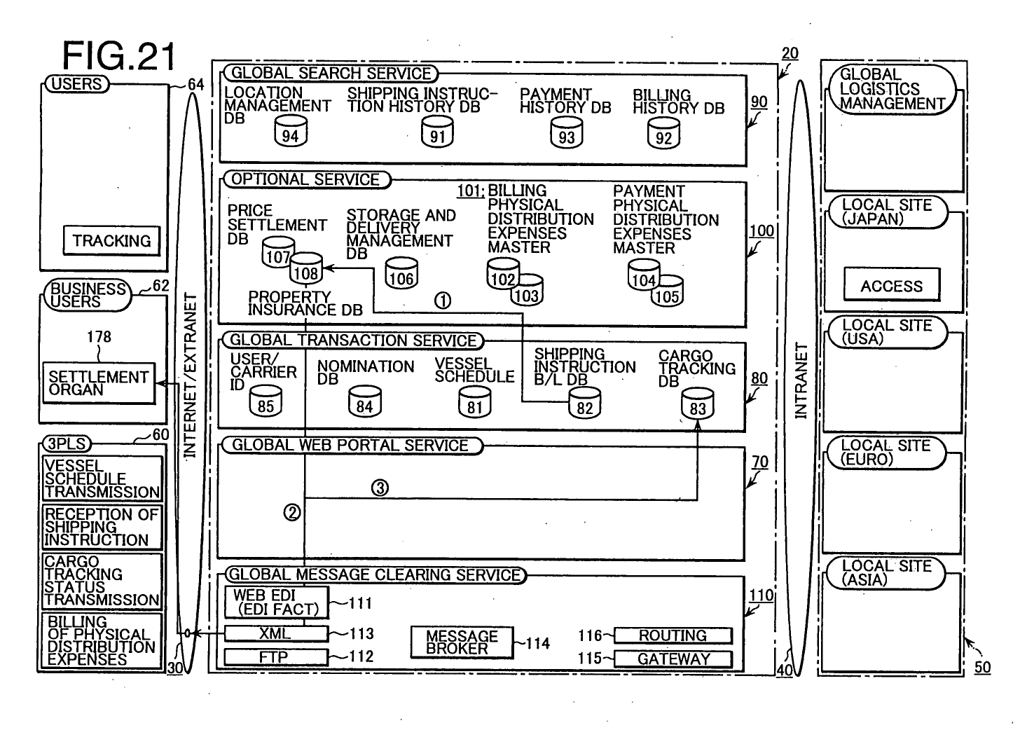

When the arrival of a shipment to the destination of cargo completes, a settlement instruction of the cargo price is issued to the database 108 for price settlement by the use of the information of a bill of lading recorded in the database 82 for shipping instructions as shown in FIG. 21.

Herein, the instruction timing of the price settlement is based on the previously fixed settlement timing, which is obtained by the search of the cargo tracking information. The price settlement information is delivered from the price settlement database 108, which received the instruction of the price settlement, to a designated settlement organ (such as a bank) through the Internet 30. When the arrival of the shipment to the destination of the cargo completes, the tracking information concerning the cargo is deleted from the cargo tracking database 83.

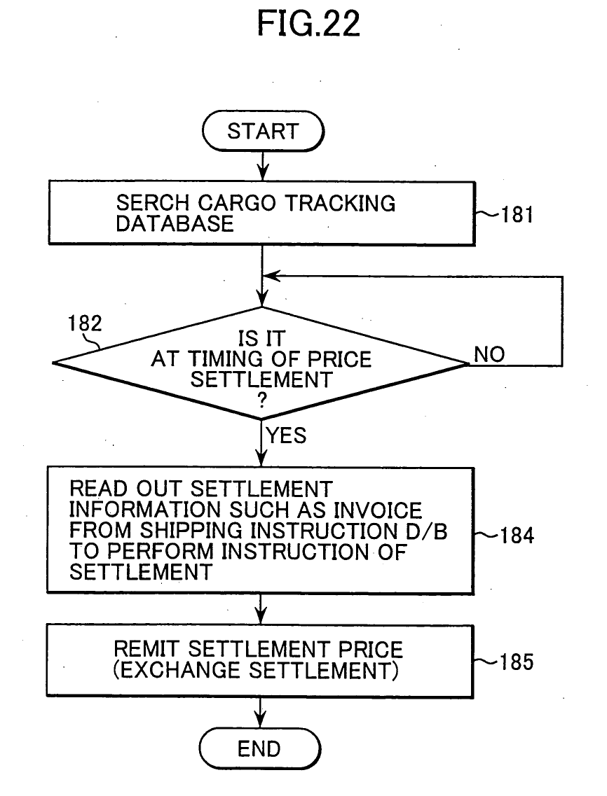

FIG. 22 is a flowchart showing an example of the price settlement processing. The information indicating the timing of the price settlement is searched for among the tracking information of the cargo by the search of the cargo tracking database 83 (steps 181, 182). The completion of the shipping or the completion of the arrival of the shipment can be searched for by the search of the ETD (Estimated Time of Departure) information or the search of the EDA (Estimated Time of Arrival) information.

When the information indicating the corresponding price settlement timing is searched for, the information of the bill of lading is read out next from the database 82 and the settlement instruction is issued (step 184). The settlement letter is transmitted to the settlement consignee (such as a bank) through the Internet 30 as electronic data, and then the settlement processing ends (step 185).

(8) Property Insurance Processing System

Because the delivery of the cargo to an destination has an unknown risk of the damage of the cargo, an insurance for the transport of the cargo (cargo insurance) is taken out from the consideration of the risk. An insurance contract is ordinarily made by an offer of an insurance contract to an insurance agency or an insurance company (property insurance company) and an issuance of a letter of approval (insurance policy) to the offer by the agency after the confirmation of the contents of the offer.

When the total concentrated physical distribution management system 20 is configured as mentioned above, an application can automatically be drafted up on the portal site side. This is why the shipping instruction information, the information of the bill of lading, and the like among the information necessary for the taking out of insurance have already been stored in the shipping instruction database 82, and then the insurance can be taken out by the provision of the information such as lists of insurance companies and insurance premium rates on the portal site side besides those pieces of information.

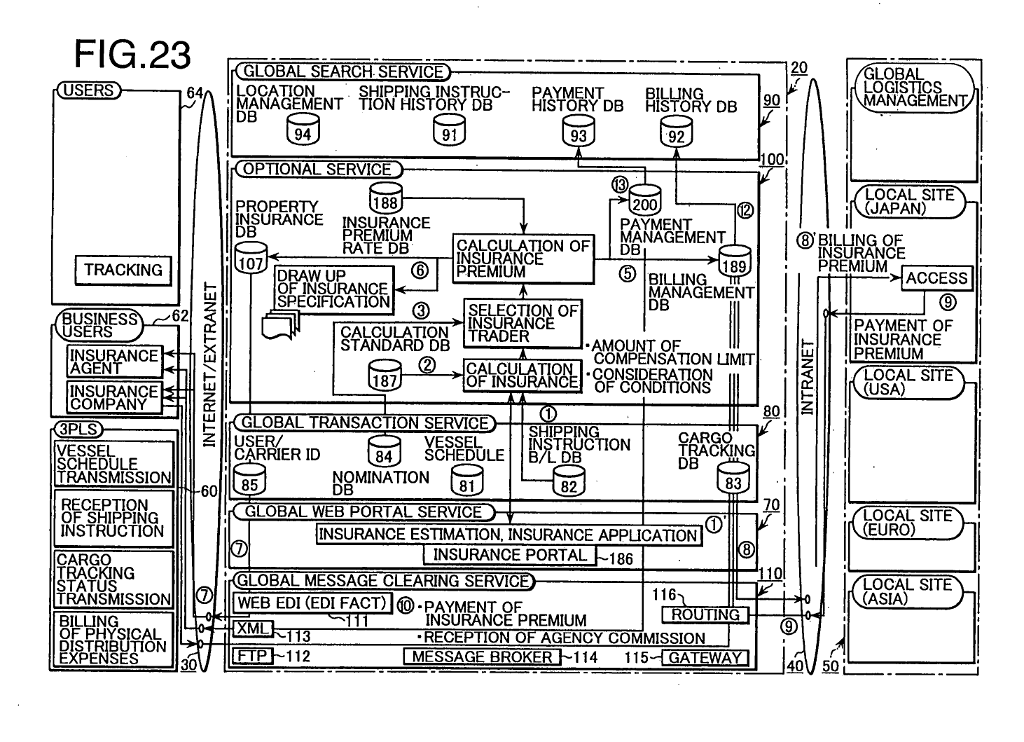

Next, an overall property insurance processing system that drafts up insurance contract articles, hands over the insurance applications on which the information is recorded to the insurance agencies and the insurance companies, and on the other hand, bills the calculated insurance premiums to the cargo consignors (insurers), and pays the insurance premiums for the insurance companies will be described by reference to FIG. 23.

When the software for operating the processing system starts, at first, an offer of insurance is performed to the insurance portal 186, and the estimation processing of insurance is thereby processed. For the estimation, the shipping instruction information, the information of the bill of lading, and the like are taken out from the shipping instruction database 82. At the same time, insurance information is taken out from a database 187 for the calculation of insurance. Then, the insurance is calculated according to the kind of insurance such as a cargo insurance and a transport insurance in consideration of the limitation amount of indemnity and the like. When the insurance is determined, an insurance trader (insurance agency or property insurance company) is successively determined. The insurance trader is selected among the insurance traders nominated previously and stored in the database 84.

After the determination of the insurance trader, next, an insurance premium rate is taken out from the insurance premium rate database 188, and an actual insurance premium to the calculated insurance is calculated. When the insurance trader, the insurance and the insurance premium are respectively determined, these pieces of information are stored in the property insurance database 107, and the insurance offering information is changed in conformity of the EDI to be delivered to the insurance agency or the property insurance company 62 through the Internet 30. After the calculation of the insurance premium, it is possible to draft up detailed documents for an insurance contract, and is to be able to mail them to the insurance company and the like.

Besides, in any one of the cases where insurance offers are changed into electronic data and where the offers are written on papers, the same business as that of an ordinary insurance agent can be performed to issue an insurance policy. However, when the insurance business is performed as a business for gaining profits, a qualified person must do that.

On the other hand, when the calculation of the insurance premium ends, this time, the insurance premium to be paid and the identification number of the cargo consignor side are stored in an insurance premium billing management database 189 as well as the database 92 for storing billing history information. And then the insurance premium and the like are stored in an insurance premium payment management database 200 and the payment history database 93, respectively.

The payment insurance premium and the like stored in the billing management database 188 are delivered to the local site 50 through the intranet 40 for the billing of the insurance premium. The local site 50 transmits a payment instruction of the insurance premium to the portal site side through the intranet 40 similarly. On the portal site side, the payment instruction is collated with the information in the billing management database 189. When the payment instruction agrees with the information in the billing management database 189, the corresponding insurance premium is paid to the insurance agency or the insurance company 62 from the payment management database 200. The confirmation of the payment of the insurance premium (reception confirmation) is also performed through the Internet 30.

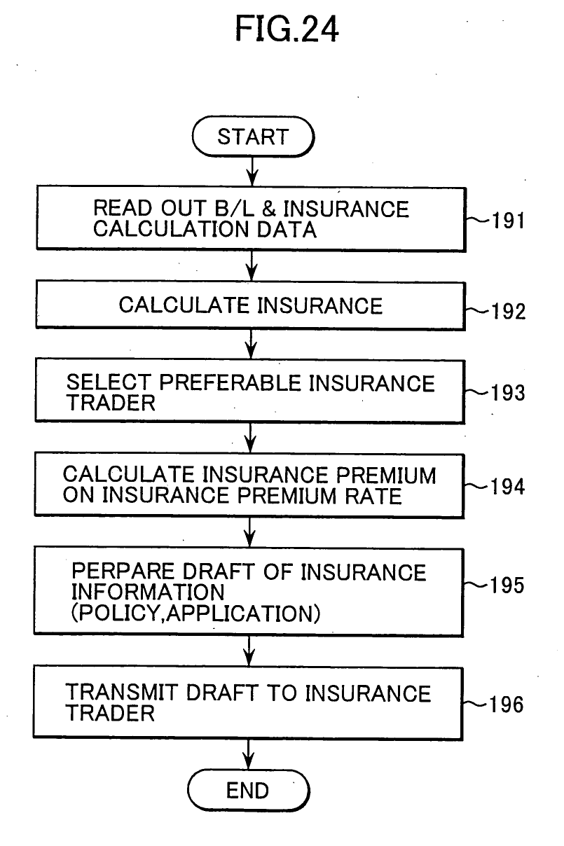

Successively, an example of the property insurance processing will be described by reference to FIG. 24.

At first, the information of the bill of lading and the information of calculation standard of insurance are read out from the databases 82, 187 (step 191), and the insurance to the cargo is calculated on the basis of those pieces of information (step 192). Successively, nominated insurance traders are read out from the database 84, and the preferable insurance trader that covers the cargo transportation route among them (step 193). After that, the information of the insurance premium rates are read out from the database 188 for the calculation of the insurance premium to the cargo by reference to the insurance premium rates (step 194).

After the end of the calculation of the insurance and the insurance premium, the draft (electronic data or documents) of the insurance documents is prepared by the reference to the database 107 (step 195), and the draft information is delivered to the property insurance company (including an insurance agency) 62 through the Internet 30 (step 196). The property insurance company ends the drafting of an insurance policy by writing necessary items such as the number of the policy into the delivered insurance documents to send the insurance policy to the insurance contractor (the cargo consignor or a manager of the portal site who is an agent of the cargo consignor). Besides, electronic information (electronic insurance bond) having the same contents as those of the insurance policy is sent to the insurance contractor.

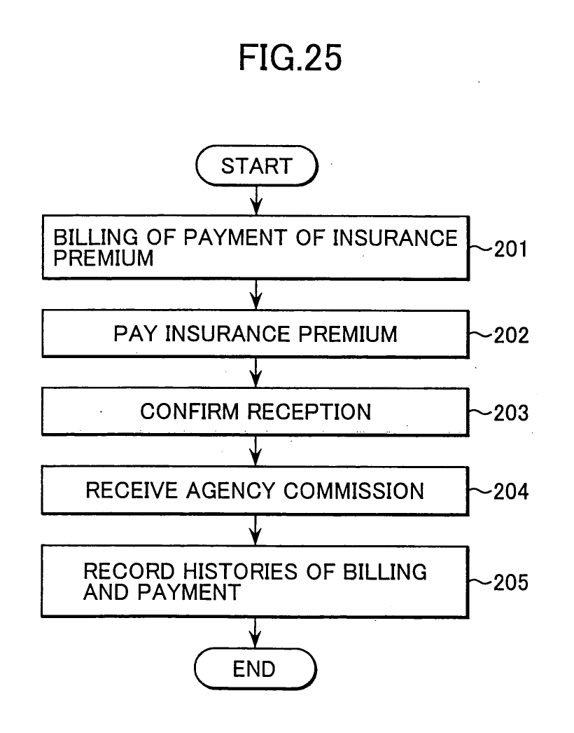

The billing and the payment of the thus made insurance are also performed electronically. That is, the electronic settlement processing is performed. An example of the processing will be described by reference to FIG. 25.

First, the billing information of the insurance premium is transmitted from the portal site side to the cargo consignor side through the intranet 40 (step 201). Next, the information of the insurance premium payment instruction from the received cargo consignor side is recorded in the billing management database 189 through the intranet 40 (step 202). On the portal site side that have received the insurance premium payment instruction, the payment of the insurance premium is performed to the designated insurance trader through the Internet 30, and on the insurance trader side, a receipt is electrically issued (step 203).

In the case where the portal site side functions as an insurance agency, namely the portal site side is under circumstances that a qualified person can make insurance documents, the draft of the insurance policy has a value as an insurance policy as it is. Accordingly, when the insurance trader has received the insurance premium, agency charges are oppositely transferred to the portal site side from the insurance trader site 62 (step 204). When the procedures end, the history of the insurance billing acts is recorded in the database 92, and the history of the payment acts of the insurance is recorded in the database 93 to end the series of the processing (step 205).

(9) Insurance Compensation Claiming Processing

It is considerable that the damage of the cargo is broken out during the delivery of the cargo. That is, the damage is such that the cargo is damaged or the cargo is scraped owing to an accident. When such damage is broken out, the problem of the payment of damages should be processed, because the insured can use his or her right to indemnity and the insurance trader bears the payment responsibility of the damages.

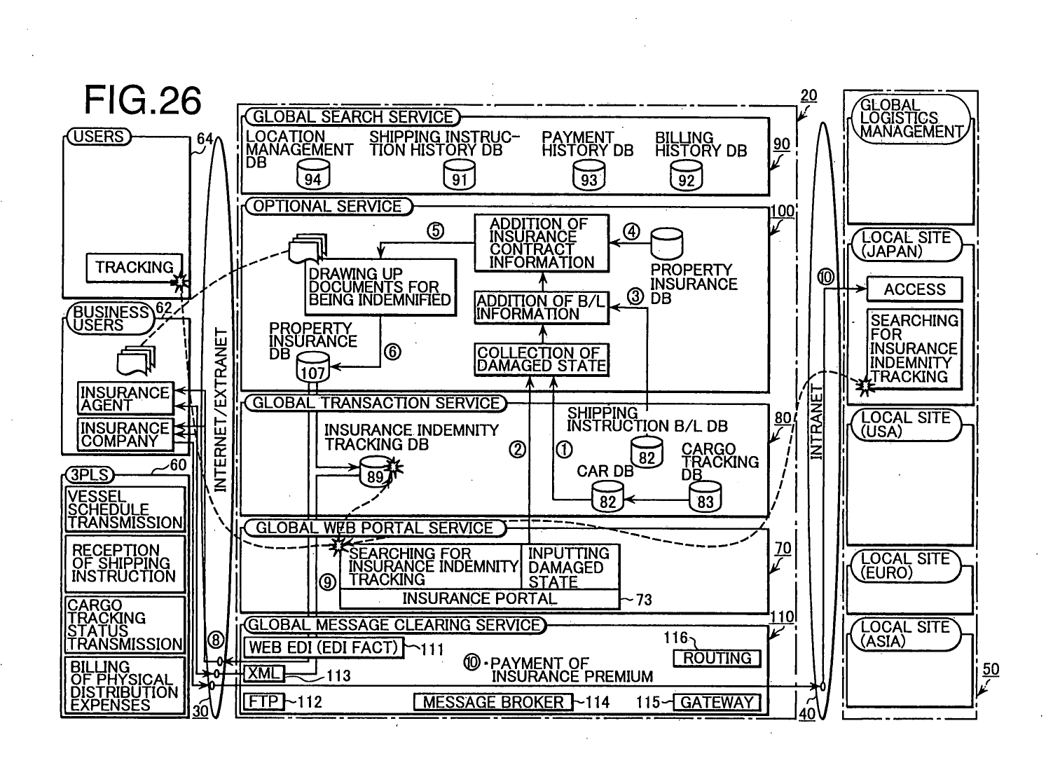

What damage cargo received in which transportation route is recorded in the cargo tracking database 83 as shown in FIG. 26. The recorded information, especially only the damage information, is also recorded to a dedicated database such as a CAR (Cargo Abnormal Report) database 88.

As a damage status information other than the information recorded in the database 88, pictures photographing the scene of the accident and the like can be considerable. These pieces of the damage status information is collected by means of especially the insurance portal among the portal sites.

Then, the amount of the insurance indemnity is calculated on the basis of the damage status collected through the insurance portal 73, the damage status obtained from the CAR database 88, the information of the bill of lading, and the contents of the insurance contract from the database 107. The documents for the insurance indemnity (electronic data or paper documents) are drafted on the basis of the amount of the insurance indemnity, and the insurance indemnity information made as electronic data is once recorded in the property insurance database 107, and is delivered to the insurance trader site 62 through the Internet 30. The insurance indemnity documents in the shape of paper documents can also be mailed to the insurance trader. The insurance indemnity business can be deputized. The insurance indemnity information is stored in the insurance indemnity tacking database 89, too, so that insurance traders and customers can inspect it, not to mention the cargo consignor.

Consequently, the electronic total physical distribution management system 10 is configured so that the insurance trader can directly access to the tracking database 89 through the Internet 30 for confirming the damage status. In the present embodiment, the system is configured so that, when the damage status is confirmed, the insurance trader calculates the amount of the property insurance to pay the insurance directly to the cargo consignor through the Internet 30 and the intranet 40. Incidentally, the cargo consignor or the customer can confirm the damage status by accessing the items of the insurance indemnity tracking search of the insurance portal.

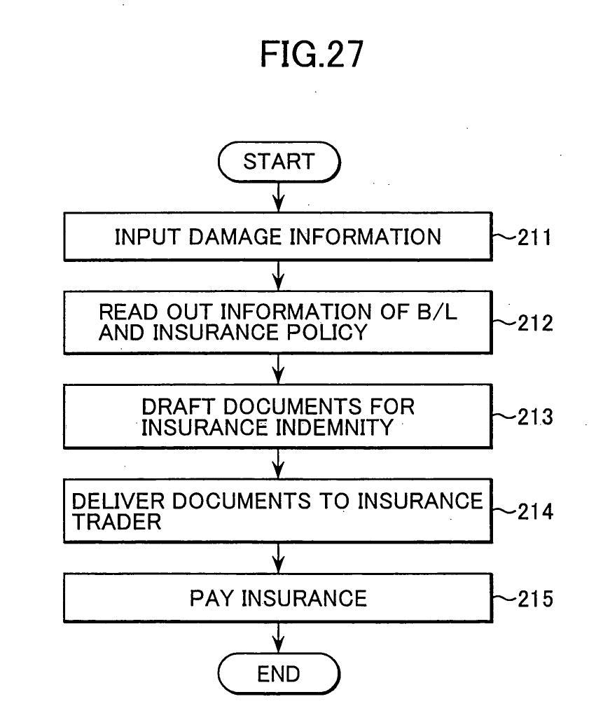

FIG. 27 is a flowchart showing an example of the insurance indemnity processing. In the processing, the damage status of cargo is obtained (step 211), and the information of the bill of lading and the information of the insurance contract are respectively obtained (step 212). The amount of the insurance indemnity is calculated on the basis of these pieces of information, and documents (draft) of the insurance indemnity are prepared (step 213). Then, the billing of the insurance indemnity is thereby transmitted to the insurance trader (step 214). When the insurance indemnity is confirmed, the insurance trader pays the insurance indemnity to the insurance contractor, which ends the series of insurance indemnity processing (step 215).

(10) Quality Grading Evaluation of Insurance Traders and the Like, Selection Standard of the Preferable Trader, and Update Processing

To nominate a plurality of physical distribution traders and insurance traders to register them in the database 84 is a requirement for shipping the consigned cargo to the destination safely according to the delivery schedule at a reasonable price and for being capable of engaging for enough indemnity even if the cargo has an accident. As a criterion of a physical distribution trader and an insurance trader for the meeting of the requirement, as to the physical distribution trader, the history information such as whether the cargo was transported as scheduled and arrived safely in a past delivery schedule or not, and so forth are important. Moreover, as for the insurance, past history information such as whether the insurance premium is cheap, and whether the contents of the indemnification are full, and whether the payment of insurance was rapid, and so forth are important.

These pieces of information are important criteria at the time of the next updating, and the registration of an unqualified trader is deleted. The update processing is performed under overall judgment on the basis of the information of the past cargo tracking database 83, the property insurance database 107 and the like. The update processing of the trader can be performed either side of the portal site side or the side of the physical distribution management group located in the local site 50. Thereby, an overall physical distribution management system capable of being relied by consignors can be constructed.

(11) Bill of Lading Issuance Processing System

When the transport contract is concluded between the consignor and the consignee for transporting the cargo, a B/L (Bill of Lading) that makes the contents of the contract is issued. The bill of lading is issued after the shipping company confirms that the cargo is shipped on the designated ship. On the bill of lading, there are written the name of the shipping company, the number of the B/L, the issued data of the B/L, the name of the forwarding agent (ordinarily, a sea cargo trader), the names and the quantities of the consignor, the consignee and the cargo, and physical distribution basic six information (who, what, how many, when, from which, and to which), and so on.

The aforesaid information to be filled is an example, and the contents to be filled on the actual bill of lading are various to be not less than 50. Consequently, the issue of the bill of lading is bothersome and troublesome. And costs produced by it are not negligible.

Recently, some shipping data and some settlement data are exchanged between a manufacturer being a consignor and a trading company or a shipping company in conformity with the EDI (Electronic Data Interchange). However, the bill of lading is not begun to be issued in conformity with the EDI yet. It is because some contents to be filled prelates to both of a consignor side and the shipping. Consequently, a shipping company must obtain the information from the consignor side and write the information into the B/L on the shipping company side.

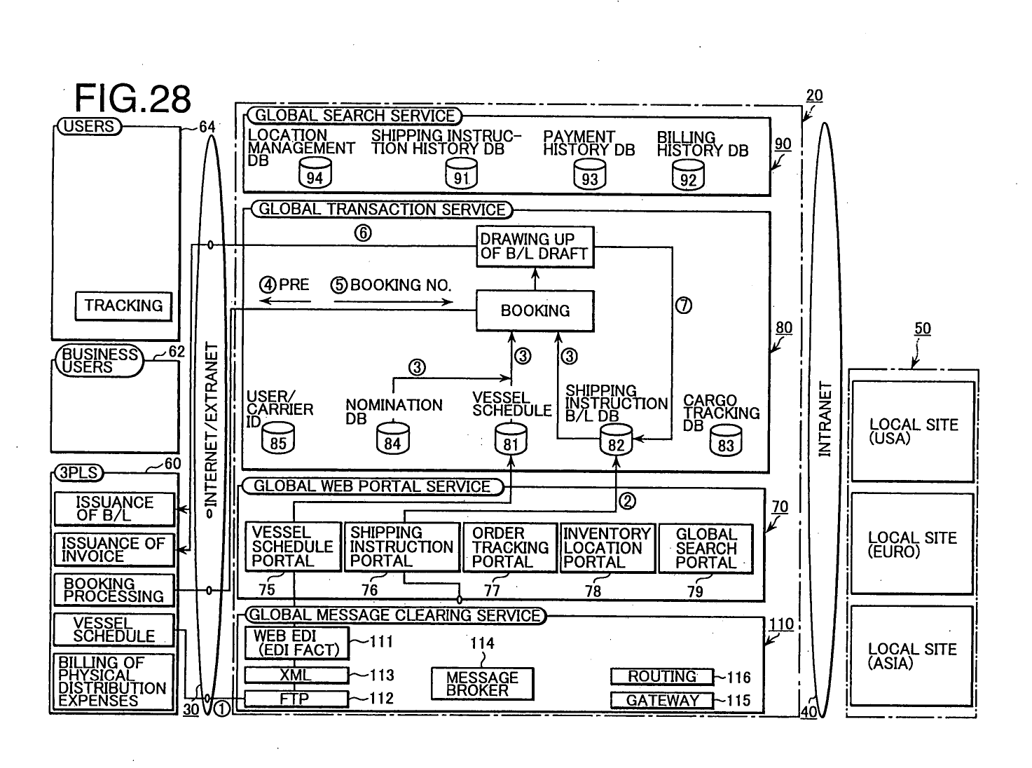

Actually, until the ship is loaded with the cargo that has been consigned to a consignee (physical distribution trader) by a consignor, information is exchanged between the consignor and the physical distribution trader several times. Accordingly, if the information owned by each party is fully written on the bill of lading to fill a corresponding item of the bill at every chance of the information exchanges, the bill of lading is completed only by the filling of the number of the bill (B/L number) and the data of the issue of the bill by the shipping company when the ship is loaded with the cargo. Next, an embodiment of the issuance processing system of the bill of lading will be described by reference to FIG. 28.

As described above, as commercial transaction systems utilizing the Internet, the EDI, especially the EDIFACT being an international standard concerning the online business such as the reception of an order, the placement of an order, settlement and the like, the XML (eXtensible Markup Language) being a page description language in place of the HTML (Hyper Text Markup Language), and the like are utilized. Accordingly, on the portal site side, the database server 70 is configured to function as the EDIFACT server necessary for electronic commercial transactions as shown in FIG. 2.

On the other hand, on the physical distribution trader site 60 side, a portal site to be connected with the Internet 30 is equipped, too, and in the portal site, as described above, the EDIFACT server is also equipped as well as the various servers necessary for the execution of the intercommunication of the information through the Internet 30.

In the concentrated physical distribution management system 20, a system for automatically issuing a bill of lading is constructed as well as the system for processing the aforesaid physical distribution management system. The system for automatically issuing the bill of lading will be described by reference to FIG. 28. In the database server 70, although it is not shown, a database for storing the delivery information of the cargo and for updating the information is equipped as well as the databases for storing the booking information of a cargoer (bottom) and the like. And in the first database section 80, as described above, the database 82 for storing the information of a bill of lading is equipped.

The system for automatically issuing a bill of lading is equipped with the application software for issuing an invoice to the physical distribution trader site 60 in response to an delivery instruction (delivery order) from the consignor side and for transmitting the invoice to a forwarding trader or a sipping company, and the application software for transmitting the information of an altering (detour) instruction of the transportation route or the like of the consigned cargo to the forwarding company or the shipping company in addition to the application software necessary for issuing a finally completed bill of lading by utilizing the booking information, the received delivery information from the consignor side and the like.

Successively, the details of the issuing processing of a bill of lading will be described. The processing is started by the acceptance of an order of the cargo delivery. Although the order is issued from the local site 50 side in many cases, there is shown a case in which the order is directly input by means of the terminal unit on the portal site side in an example shown in FIG. 28. The shipping instruction information is stored in the database 82.

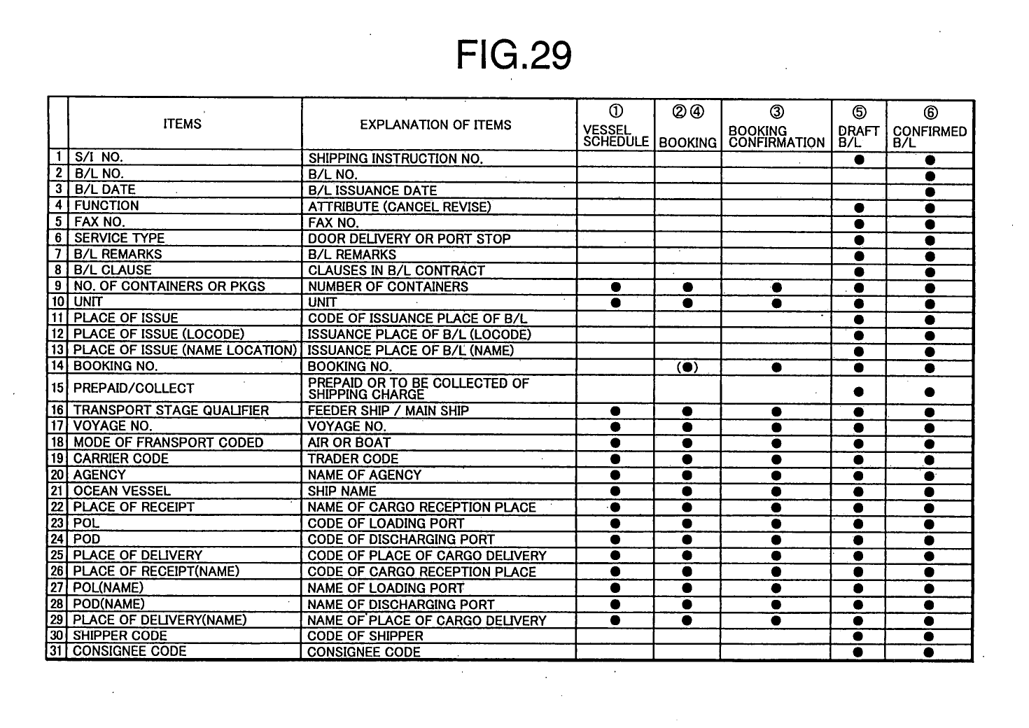

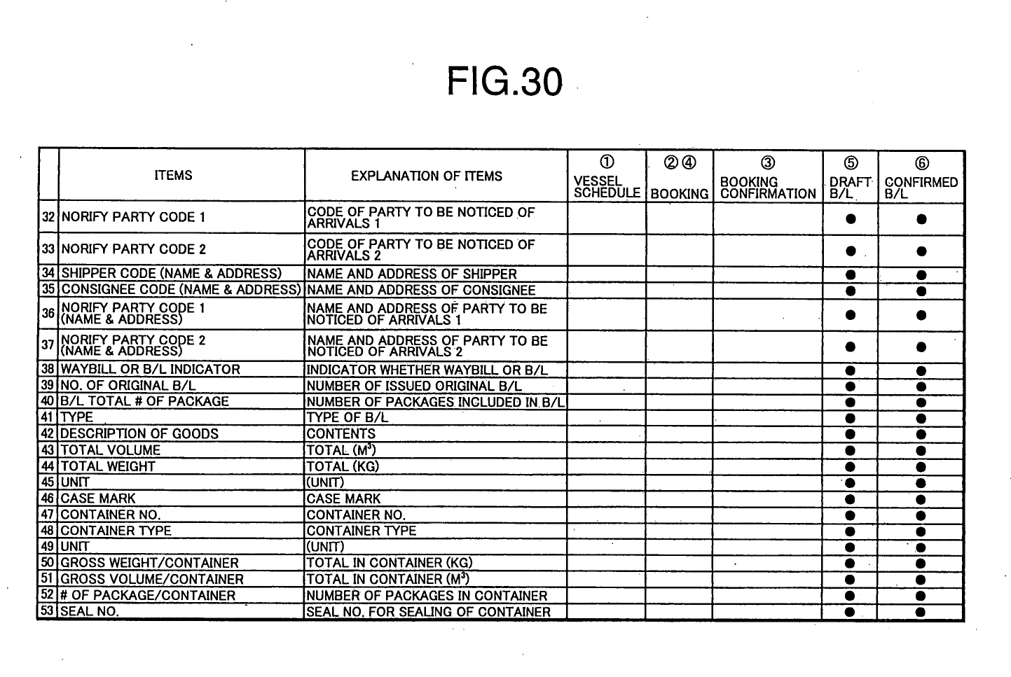

In FIG. 28, the latest booking information (vessel schedule) is acquired from the physical distribution trader, and it is examined whether or not there is a shipping company having a service for the transportation route to be consigned in the booking information by reference to the shipping instruction information, the list of physical distribution traders and the like. As the vessel schedule, one stored in the database 81 as the latest information is ordinarily used. FIG. 29 and FIG. 30 show the contents of the vessel schedule.

As apparent from Fig. 29 and FIG. 30, there are 53 items necessary for the bill of lading. As the information to be delivered as the vessel schedule, the contents of the item numbers 9, 10 (the numbers of containers) and the contents of the item numbers 16-29 (main fourteen items such as the ship name and the loading port besides the distinction of the services whether by a ship or by a plane) indicated by filled circles in column \mathring{1} in FIG. 29 are transmitted from the physical distribution trader site 60 as an EDIFACT data.

When a vessel schedule accorded with the purpose exists, pre-booking is performed to the physical distribution trader site 60. The contents in this case are the same as those of the designated vessel schedule (column \mathring{2}).

The physical distribution trader site 60 sends back the booking information with an attached booking number (item number 14 in FIG. 29) to the portal site side (column \mathring{3} except the item number 14). The portal site confirms the booking information (column \mathring{4} including item number 14).

Successively, on the portal site side, a draft of a bill of lading is drafted by the writing of corresponding information in corresponding items on the basis of the physical distribution basic six information (column \mathring{5}). That is, the detailed physical distribution information such as a shipper, a consignee, a destination including items written in FIG. 30 on the basis of the information of who, what, how many, when, from which place, and to which place.

The information effective in this case is the shipping instruction information including the physical distribution basic six information. Moreover, by the supplementation of the items necessary for the bill of lading such as the number of the shipping instruction and the place at which the bill of lading was issued in addition to those pieces of information, a draft having all of the items (51 items) to be filled except the number of the bill of lading and the issuance date thereof is finally prepared (column \mathring{5}).

The prepared draft is transmitted to the physical distribution trader, and the number of the bill of lading and the issuance date thereof are filled by the physical distribution trader after the cargo is confirmed to complete the final bill of lading (column \mathring{6}). The number of the bill of lading and the bill of lading with the issuance date become effective, and have validity as a formal bill. As described above, almost all pieces of the information concerning the bill of lading are exchanged in processes of the exchange of information between the physical distribution trader and the portal site side, and then the draft of the bill of lading can relatively easily be prepared in real time by the filling of corresponding items in the exchange processes. Incidentally, a part of the information of the bill of lading can be utilized as the tracking information of the cargo, too.

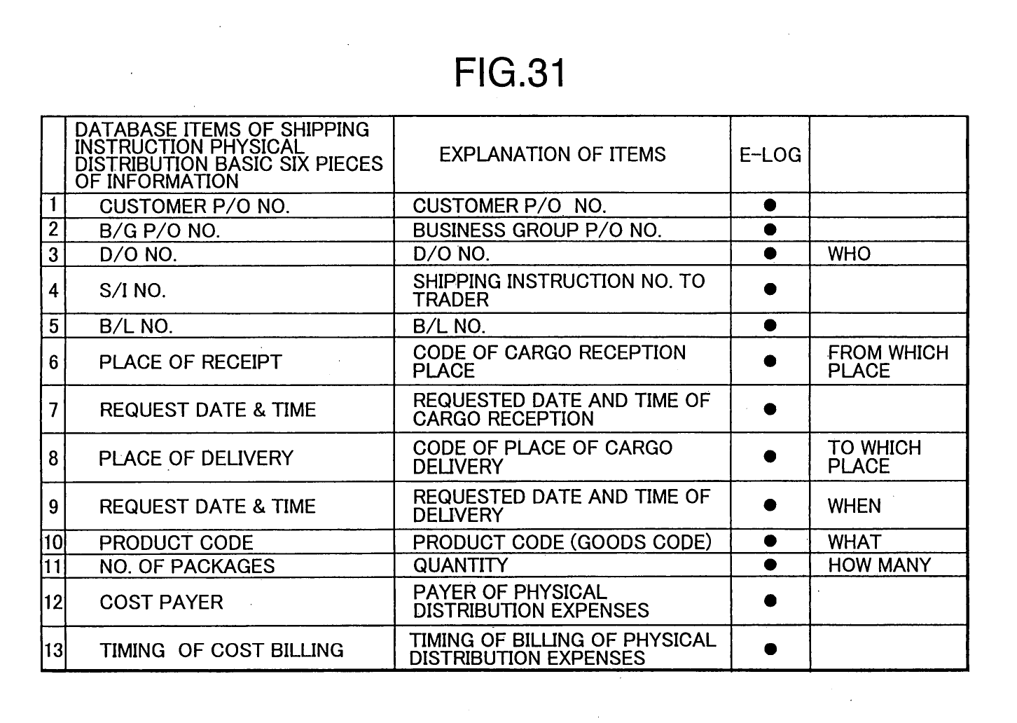

Incidentally, various pieces of information related to the physical distribution basic six pieces of information (such as the shipping order number of a customer and a shipping instruction number to a trader) shown in, for example FIG. 31, are also stored in the shipping instruction database 81 as the draft making information of a bill of lading in addition to the aforesaid physical distribution basic six information.

Moreover, the system for automatically issuing a bill of lading has a function of issuing an invoice of an cargo to a shipping trader or a shipping company when a draft of a bill of lading is delivered to a physical distribution trader and a function of receiving arrival information of the cargo arrived at a physical distribution trader from a foreign country on the portal site side in addition to the function of the issuance processing of a bill of lading. The portal site side enters in the preparation of import procedures on the basis of the information. Furthermore, the system obtains the damage information (CAR information) of the cargo from the latest tacking information of the cargo to store the damage information in the cargo tacking database 82 on the portal site side.

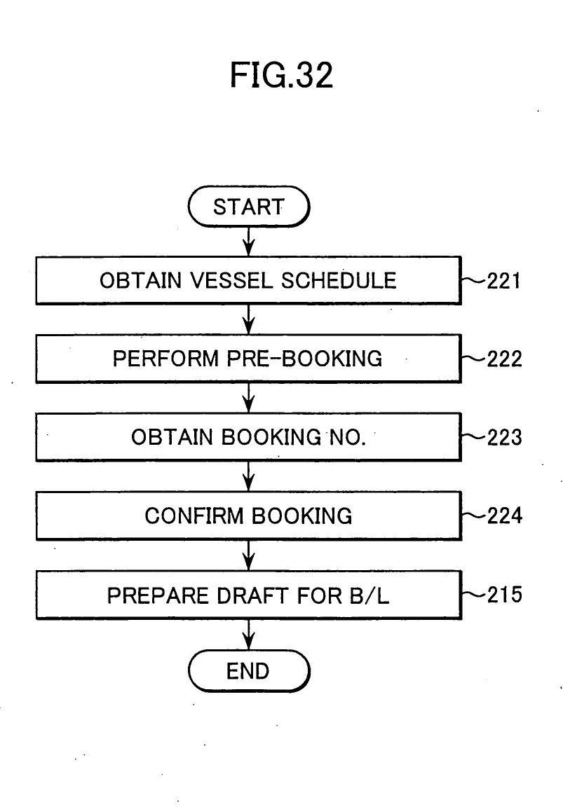

A concrete instance of the aforesaid automatic issuance processing of a bill of lading will be explained by reference to FIG. 32. In FIG. 32, at first, pre-booking is performed by the acquisition of a vessel schedule (booking information) (steps 221, 222). Actually, a vessel schedule stored in the database 81 is utilized. Next, the processes of the issuance of a booking number by a physical distribution trader and the confirmation of the booking are performed (steps 223, 224). After that, a draft of a bill of lading is made to be delivered to the physical distribution trader (step 225). After that, the physical distribution trader fills the number of the bill of lading and the issuance date thereof, and then a shipping company issues the bill of lading.

At the same time, an invoice of the cargo is forwarded to the shipping trader and the like. The forwarding of the bill of lading performed by the physical distribution trader site 60 may be in conformity wit the EDI, or the bill of lading may be sent by fax or mail in a document form. Corresponding items are processed from respective standpoints in a series of information exchanging processes, and then the issuance processing of the bill of lading ends.

Incidentally, although in the aforesaid embodiment, the invention is applied to a case where the information concerning the physical distribution of cargo that is exported to foreign countries from a domestic trader is electronically exchanged, it can easily be understood that the present invention can be applied to a physical distribution management system concerning imported cargo and a physical distribution management system concerning the physical distribution performed between domestic traders.

Although the invention has been described in its preferred form with a certain degree of particularity, obviously many changes and variations are possible therein. It is therefore to be understood that the present invention may be practiced than as specifically described herein without departing from scope and the sprit thereof.

1-20. (canceled)

21. An automatic drafting method of a draft of a bill of lading, said method comprising the steps of:
performing pre-booking of a specific outgoing vessel schedule selected among previously obtained outgoing vessel schedule information at a time of receiving a consigning order of cargo delivery, and using information concerning a designated outgoing vessel schedule as draft information for the bill of lading;
issuing a booking instruction of the outgoing vessel schedule information for confirmation returned with an attached bill reservation number of the bill of lading;
making new draft information for the bill of lading by adding shipping instruction information to the outgoing vessel schedule information for confirmation in response to a shipping requirement; and
transmitting the new draft information for the bill of lading as final draft information for the bill of lading, whereby the draft information of the bill of lading is automatically made.

22. The automatic drafting method of a draft of a bill of lading according to claim 21, wherein
said final draft information for the bill of lading becomes an effective bill of lading by addition of a bill number and an issuance date of the bill.

23. The automatic drafting method of a draft of a bill of lading according to claim 21, wherein
said outgoing vessel schedule information includes at least physical distribution basic six information.

24. An automatic making apparatus of draft information for a bill of lading, said apparatus comprising:
storing means for storing outgoing vessel schedule information;
storing means for storing cargo shipping instruction information;
booking means for performing booking of a specific outgoing vessel schedule on a basis of the outgoing vessel schedule information and the shipping instruction information, both being read out from the two storing means;
making means for making draft information of a bill of lading to be issued to the cargo on a basis of the outgoing vessel schedule information and the booking information; and
delivery means for delivering the booking information and the draft information, whereby
the draft information made by said making means is delivered to a shipping company side, and the shipping company side writes a bill number and an issuance date of the bill for making the bill of lading of the cargo.

25. The automatic making apparatus of a draft of a bill of lading according to claim 24, wherein
said delivery means delivers the booking information and the draft information through a communication network line.

26. An automatic issuing system of a bill of lading, in which a site to transmit a cargo shipping instruction and a site on a physical distribution trader side are mutually connected with a communication network line and information circulates as electronic data, the site on the shipping instruction side comprising:
storing means for storing outgoing vessel schedule information;
storing means for storing shipping instruction information; and
draft information storing means for storing information related to an outgoing vessel schedule at a time of performing booking of a specific outgoing vessel schedule selected in a previously obtained outgoing vessel schedule table when a consigning order of cargo delivery is received;
the site on the physical distribution trader side being comprising:
delivery means for delivering a latest outgoing vessel schedule information;
information of a bill of lading confirming means for confirming delivery of booking information on the physical distribution trader side to add a bill booking number; and
bill of lading issuing means for attaching a bill number and a bill issuance data to received draft information of a bill of lading to issue the bill of lading to the cargo, whereby
the draft information for the bill of lading are added in sequence in electronic data exchanging processes between both of the sites to complete the bill of lading.

27. The automatic issuing system of a bill of lading according to claim 26, wherein
said outgoing vessel schedule information includes at least physical distribution basic six information.
